(19) United States
(12) Patent Application Publication
(10) Pub. No.: US 2006/0241878 A1
(43) Pub. Date: Oct. 26, 2006

(54) Surface paneling module, surface paneling module arrangement and method for determining the distence of surface paneling modules of the surface paneling module arrangement to at least one reference position, processor arrangement, textile fabric structure and surface paneling structure

(75) Inventors: Stefan Jung, Munchen (DE); Christi Lauterbach, Hohenkirchen-Siegartsbrunn (DE); Guido Stromberg, Munchen (DE); Thomas Sturm, Kirchheim (DE); Annelie Stöhr, Munchen (DE); Warner Weber, Munchen (DE)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(73) Assignee: INFINEON TECHNOLOGIES AG, Munchen (DE)

(21) Appl. No.: 10/538,594

(22) PCT Filed: Dec. 10, 2003
(86) PCT No.: PCT/DE03/04060

§ 371 Date: Apr. 7, 2006

(30) Foreign Application Priority Data
Dec. 10, 2002 (DE) 102 57 672.6
Aug. 18, 2003 (DE) 103 37 940.1

(51) Int. Cl. G06F 15/00

(52) U.S. Cl. 702/60; 702/158

(57) ABSTRACT

The invention relates to a surface paneling module that includes a power supply connection and a data transfer interface as well as a processor that is coupled to the power supply connection and the data transfer

### BACKGROUND

One embodiment of the invention relates to a surface paneling module, a surface paneling module arrangement, a method for determining the distance from surface paneling modules in the surface paneling module arrangement to at least one reference position, to a processor arrangement, to a textile fabric structure and to a surface paneling structure.

In many areas of building technology and in many exhibition structures, there is a need to lay sensor systems and actuator systems, such display elements, in floors, walls or ceilings in a simple manner. In this case, the floors, walls or ceilings should optionally or in combination be able to perceive contact and/or pressure and shall be able to react with a visual indication or an audible indication to the existence of contact and/or pressure.

The required large-area sensor system or large-area display units are intended to have the capability to be fitted and operated in a simple, low-cost and fault- and error-tolerant manner. In particular, the installation of the sensor system or actuator system should be adaptable to a wide range of sizes and geometric shapes of a floor, a wall or a ceiling.

For integration of a sensor system or actuator system in a floor, a side wall or the ceiling of a room, it is known for the desired sensors and actuators to be laid in the floor, the wall or the ceiling in a customer-specific solution.

The specific solutions require a large amount of planning effort, in which case it is in each case necessary to specify precisely, during the planning of the building, the locations at which the respective sensor and actuator systems must be provided.

With such a specific solution, each sensor and each actuator is driven individually and each is provided with electrical power lines and data lines separately. The data lines have been routed individually or via routers, which have to be installed separately, to a central computation unit. Furthermore, according to the prior art, complex control software is required to drive the respective sensors and actuators, and this must be matched to the specific geometry of the respective specific solution, in order to allow two-dimensional or three-dimensional detection of objects, in particular of people.

Specific solutions such as these are therefore unsuitable for the mass market, since they are inflexible and expensive.

Furthermore, T. F. Sturm, S. Jung, G. Stromberg, A. Stohr, A Novel Fault Tolerant Architecture for Self-Organizing Display and Sensor Arrays, International Symposium Digest of Technical Papers, Volume XXXIII, Nr. II, Society for Information Display, Boston, Mass., May 22 to 23, 2002, pages 1316 to 1319, 20021 discloses an error-tolerant and fault-tolerant architecture of self-organizing display areas and sensor areas in the field of microelectronics, or in other words in the field of Microsystems.

U.S. Pat. No. 4,387,127 describes a control panel with buttons and a control board.

Furthermore, WO 99/41814 A1 describes a floor paneling module in which electrical power cables or data cables are permanently installed and are coupled to an electrical power cable or data cable for another floor paneling module. In addition, the floor paneling module may contain computer chips and sensors, for example for detection of temperature or of a weight which is loading the floor paneling module.

One general problem with the processor arrangement that is known from T. F. Sturm, S. Jung, G. Stromberg, A. Stohr, A Novel Fault Tolerant Architecture for Self-Organizing Display and Sensor Arrays, International Symposium Digest of Technical Papers, Volume XXXIII, Nr. II, Society for Information Display, Boston, Mass., May 22 to 23, 2002, pages 1316 to 1319, 2002 is that each processor must be equipped with four or six mutually independent bidirectional communication links to the respective four or six adjacent processors.

Most modern commercially available, low-cost microcontrollers, that is to say processors which are offered as the central control element in the processor elements which contain the processors, have standardized communication interfaces, but the number of the standardized communication interfaces which are normally provided by one microcontroller is considerably less than the four or six communication interfaces which are required in the processor arrangement described above.

Thus, in the processor arrangement described in T. F. Sturm, S. Jung, G. Stromberg, A. Stohr, A Novel Fault Tolerant Architecture for Self-Organizing Display and Sensor Arrays, International Symposium Digest of Technical Papers, Volume XXXIII, Nr. II, Society for Information Display, Boston, Mass., May 22 to 23, 2002, pages 1316 to 1319, 2002, additional communication modules will have to be used in each processor element for the communication interfaces of the processors, in order to provide the additionally required communication interfaces, thus resulting in a considerable increase in the material costs and the integration complexity for production of a processor arrangement.

Furthermore, various bus systems are known, such as a bus system which uses a Serial Parallel Interface (SPI interface) or alternately a bus system based on the Controller Area Network Standard (CAN standard) or a bus system in which an I²C interface is used to interchange electronic data (see C. Fenger, Phillips Semiconductors, Integrated Circuits, Application note, AN168: The I²C Serial Bus: Theory and Practical Consideration Using Philips Low-Voltage PCF84Cxx and PCD33xx pC Families, December 1988).

### SUMMARY

One embodiment of the invention integrates electronics in a floor, in a wall or in a ceiling in a simple and cost-effective manner.

Disclosed is a surface paneling module, a surface paneling module arrangement, and a method for determining the distance from surface paneling modules of the surface paneling module arrangement to at least one reference position.

A surface paneling module has at least one electrical power supply connection, at least one data transmission interface and at least one processor unit, which is coupled to the electrical power supply connection and to the data transmission interface.

One embodiment of the invention includes a module with a regular design for paneling of a surface, in one case of a floor, of a wall or of a ceiling, is additionally provided with a processor unit for electronic data processing, which processor unit can be supplied with electrical power via an electrical power supply connection that is likewise provided, and which can be supplied with the data to be processed by means of the data transmission interface.

In other words, this means that a processor unit is embedded in a regular component for paneling a surface. The individual surface paneling modules thus represent intrinsically independent units which, however, are able on the basis of the additionally provided components to interchange electronic messages via the data transmission interface in two or more surface paneling modules in a surface paneling module arrangement thus allowing, for example, local position-finding of the respective surface paneling module within the surface paneling module arrangement and/or with respect to a predetermined reference position.

For a surface paneling module, this therefore allows the position of this module to be determined very easily within an area, without any external information.

This makes it possible in a very simple and cost-effective manner to design each surface paneling module intrinsically in the same way for the mass market without any need to be concerned in the laying of the surface paneling modules, despite the additional electronics integrated in them, about the position at which the respective surface paneling modules must be arranged within the area that is covered by them in order that the respective surface paneling module can be unambiguously addressed within the surface paneling module arrangement.

A surface paneling module arrangement has two or more surface paneling modules, in one case a large number of surface paneling modules, which are coupled to one another by means of the respective electrical power supply connection and the respective data transmission interface.

In order to determine the distance from surfaces of a respective surface paneling module in the surface paneling module arrangement to at least one reference position with electronic messages being interchanged between processor units of mutually adjacent surface paneling modules, a first message is produced by a processor unit of a first surface paneling module, with the first message containing first distance information, which contains the distance of the first surface paneling module or the distance of a second surface paneling module, which receives the first message, from the reference position. The first message is sent from the processor unit of the first surface paneling module to the processor unit of the second surface paneling module, and the distance of the second surface paneling module from the reference position is determined or stored as a function of the distance information. The processor unit of the second paneling module furthermore produces a second message, which contains second distance information, which contains the distance of the second surface paneling module or the distance of a third surface paneling module, which receives the second message, from the reference position. The second message is sent from the processor unit of the second surface paneling module to the processor unit of the third surface paneling module. The distance of the third surface paneling module from the reference position is determined or stored as a function of the second distance information. The method steps described above are carried out for all the surface paneling modules which are contained in the surface paneling module arrangement and are coupled to one another via the data transmission interface.

Thus, once this method has been carried out, the respective position of each surface paneling module within the surface paneling module arrangement, and its distance from at least one reference position, will have been determined just by using local information.

This aspect of the invention is obviously seen in that an architecture which has been developed for Microsystems and in this context for microdata display devices and sensors, and algorithms which have been developed for this purpose, have been transferred to the macrosystems for building technology and exhibition technology, with the required processor units being embedded in the surface paneling modules, which represent regular components.

This opens up a range of new application options, which will be explained in more detail over the following text.

Fundamentally, there are no restrictions on the reference position, and the reference position is in one case a position at which a portal processor (which will be described in the following text) is located, which drives the processor units in the surface paneling module arrangement and stimulates the communication from outside the surface paneling module arrangement. The reference position may also be a position within the surface paneling module arrangement, with in this case one surface paneling module in one case being arranged at the reference position, and being associated with it. In this case, the reference position is located at the edge, that is to say in the uppermost or lowermost row or in the left-hand or right-hand column, in the situation where the processor units in the surface paneling module arrangement are arranged in rows and columns in the form of a matrix. Information is in one case transmitted in or from the surface paneling module arrangement by means of the portal processor exclusively via at least some of the surface paneling modules which are located at the edge of the surface paneling module arrangement.

This procedure means that, starting from an “input processor unit” of an “input surface paneling module” at the reference position, normally at the edge of the surface paneling module arrangement, that is to say on an outer module with respect to the surface paneling module arrangement, a first distance is allocated, for example the distance value “1”, which indicates that the input surface paneling module is at a distance “1” from the portal processor. For the situation where the distance of the surface paneling module with the processor unit that is sending the message from the reference position is inserted in the respective message, and is transmitted to the processor unit that is intended to receive the message, the first processor unit transmits the distance value “1” to the second processor unit in the first message, and the second processor unit increments the received distance value by a value “1”. The increment value “2” is now stored as the updated second distance value in the second processor unit. The second distance value is incremented by a value “1” and a third distance value is produced, which is transmitted to the third processor unit and is stored there. The corresponding procedure is carried out for processor units for all of the surface paneling modules in a corresponding manner, and the respective distance value that is associated with a processor is updated after reception of a message with distance information whenever the received distance value is less than the stored distance value.

A surface paneling module arrangement has a large number of surface paneling modules. Each surface paneling module is coupled via a bidirectional communication interface, the data transmission interface, to at least one surface paneling module that is adjacent to it. In order to determine the respective distance of a surface paneling module in the surface paneling module arrangement from a reference position, messages are interchanged between the processor units for the respective surface paneling modules, in one case between processor units of mutually adjacent surface paneling modules, with each message containing distance information which indicates the distance of a surface paneling module with a processor unit that is sending the message or a processor unit that is receiving the message from the reference position (also referred to as the distance value), and with each processor unit being designed such that the distance of its own surface paneling module from the reference position can be determined or can be stored from the distance information in a received message.

Owing to the use of only local information and the interchange of electronic messages in particular between processors of directly mutually adjacent surface paneling modules, the procedure is very robust with respect to disturbances and failures occurring in individual surface paneling modules or individual connections between two surface paneling modules.

One refinement of the invention provides for the electrical power supply connection and the data transmission interface to be integrated in a plug connector.

The data processing can be carried out electronically via electronic lines that are contained in the surface paneling module, or optically by means of optical lines integrated in these electronic lines, with at least one electrical power line being provided according to one refinement of the invention, which electrical power line couples the processor unit to the electrical power supply connection, and with at least one data line being provided which, as described above, may also be in the form of an optical data line, with the processor unit being coupled to the data transmission interface by means of the data line.

The surface paneling module may be a wall paneling module, a floor paneling module or a ceiling paneling module.

In this context, it should be noted that the invention is not restricted to use in enclosed rooms, but that the surface paneling modules can also just cover a floor that is not bounded by side walls in an exhibition configuration.

According to one refinement of the invention, the surface paneling module is designed as a tile, as a wall tile, as a parquet flooring element or as a laminate element, with which in each case a surface is covered.

In addition, at least one sensor may be integrated in the surface paneling module. The sensor may be a sound sensor, a pressure sensor (for example piezo-crystal sensor) a gas sensor, a vibration sensor, a deformation sensor or a tensile-stress sensor.

According to another refinement of the invention, the surface paneling module has at least one actuator integrated in it. The actuator is, for example, an imaging unit or a sound-producing unit, in one case a liquid-crystal display unit or a polymer electronics display unit, in general any type of display unit, or a loudspeaker which produces a sound wave, or in general any element which produces an electromagnetic wave. A further possible actuator that may be provided is an element which produces vibration. The wall tiles are, in one case, ceramic wall tiles or solid carpet tiles, for example cork flooring elements, or alternatively brick-like components, which are used analogously to Lego blocks for paneling a surface.

The surface paneling module may have a hexagonal shape, in which case each surface paneling module in each case has up to six adjacent surface paneling modules, each of which are coupled to one another via a bidirectional communication interface, in the data transmission interface. When using hexagonal surface paneling modules, this results in a very high packing density within the surface paneling module arrangement.

Alternatively, the surface paneling module may in each case have a rectangular shape, in which case each surface paneling module in each case has up to four adjacent surface paneling modules, which are each coupled to one another via a bidirection communication interface, the data transmission interface.

According to another refinement of the invention, before the determination of the distance of the surface paneling modules from the reference position, the physical positions of the surface paneling modules within the surface paneling module arrangement are determined in that, on the basis of a processor unit of a surface paneling module at an introduction point of the surface paneling module arrangement, position determination messages which have at least one row parameter z and one column parameter s (which contains the row number or column number, respectively, of the surface paneling module with the processor unit sending the message or the row number or the column number, respectively, of the processor unit receiving the message within the surface paneling module arrangement) are in each case transmitted to processor units of adjacent surface paneling modules, and the processor unit of the respective surface paneling module carries out the following steps:
if the row parameter in the received message is greater than the previously stored row number of the surface paneling module, then the surface paneling module's own row number is allocated the row parameter value z of the received message,
if the column parameter in the received message is greater than the surface paneling module's own column number, then the stored column number is allocated the row parameter value of the received message,
if its own row number and/or its own column number have/has been changed on the basis of the method steps described above, then new position measurement messages are produced with new row parameters and new column parameters, which each contain the row number and the column number of the surface paneling module with the processor unit sending the message or the row number and the column number of the processor unit receiving the message, and these are transmitted to a respective adjacent surface paneling module via the bidirectional communication interfaces.

This development further extends the concept according to one aspect of the invention of interchanging messages locally between mutually adjacent surface paneling modules, since the physical positions of the individual surface paneling modules within the surface paneling module arrangement according to this concept are simply based on the local position information which is obtained just from position information received from the directly adjacent surface paneling module. This allows a procedure which is highly robust with respect to errors or faults for the purposes of self-organization of the surface paneling module arrangement.

According to another development of the invention, in an iterative method, the surface paneling module's own distance value is changed if the previously stored distance value is greater than the received distance value (increased by a predetermined value) in the respectively received message, and in the situation where a processor unit changes its own distance value, this produces a distance measurement message and sends this via all communication interfaces to processor units of adjacent surface paneling modules, with the distance measurement message in each case containing its own distance as distance information or the distance value which the receiving surface paneling module has from the portal processor.

The distance value can be changed from its own distance value by a value that has been increased by a predetermined value, in one case by the value “1”.

The invention is suitable, for example in the following application areas:
building automation, in one case in order to improve the building convenience,
alarm systems with the position, and optionally, the weight of an entry person or object being determined,
automatic visitor guidance in exhibition sites or in a museum,
for a control system for an emergency situation, for example in an aircraft or in a train, in order to indicate an emergency escape route to passengers.

The invention can be regarded as being that desired electronic data processing and optionally desired sensor systems or display elements as well as communication network components are integrated in wall, floor or ceiling paneling systems, in a manner known per se. The paneling systems are in this context regular elements which are suitable for covering a surface in predetermined directions, in one case in an orthogonal or hexagonal arrangement.

Although the following exemplary embodiments describe a tiled arrangement, the invention is not restricted to tiles or wall tiles, but can also be used for any regular element that is suitable for surface covering or surface paneling.

One embodiment of the invention provides a processor arrangement, in which the processors that are used need not be equipped with additional communication interfaces in the processor elements.

A processor arrangement has at least one interface processor, which provides a message interface for the processor arrangement. Furthermore, a large number of processors are provided, with, at least in some cases, only those processors which are arranged physically directly adjacent to one another being coupled to one another in order to interchange electronic messages. Furthermore, a large number of sensors and/or actuators are provided in the processor arrangement, in which case each processor of the large number of processors is allocated a sensor and/or an actuator and is coupled to the respective processor in which sensor data and/or actuator data can be transmitted in the electronic messages from and/or to the interface processor. The processors which are arranged physically directly adjacent to one another at least in some cases are coupled to one another in accordance with a regular coupling topology whose degree is greater than unity.

A textile fabric structure has a processor arrangement as described above, with the processors being arranged in the textile fabric structure. Furthermore, electrically conductive threads, which couple the processors to one another, are provided in the textile fabric structure. Furthermore the textile fabric structure contains conductive data transmission threads, which couple the processors to one another. In addition, electrically non-conductive threads are provided in the textile fabric structure.

Furthermore, the electrically conductive threads and the conductive data transmission threads at the edge of the textile fabric structure are respectively provided with electrical interfaces and data transmission interfaces.

By virtue of its design, the textile fabric structure, unlike the prior art, can be produced with a large area and can easily be cut to any desired shape. It can thus easily be matched to any desired surface on which it is intended to be laid. There is no need to subsequently couple the individual processor elements (for example sensors or actuators (such as light-emitting guides) or processors) which are provided in the textile fabric structure to one another, since the processor elements are already coupled to one another within the textile fabric structure.

In other words, this means that two or more processor elements are embedded in a textile fabric structure for paneling a surface. The individual processor elements within the textile fabric structure are in one case able by virtue of the components that are additionally provided to interchange electronic messages with other processor elements in the textile fabric structure via the data transmission threads and thus, for example, to allow the local position of the respective processor element to be found within the textile fabric structure, in one case, using the method described in T. F. Sturm, S. Jung, G. Stromberg, A. Stohr, A Novel Fault Tolerant Architecture for Self-Organizing Display and Sensor Arrays, International Symposium Digest of Technical Papers, Volume XXXIII, Nr. II, Society for Information Display, Boston, Mass., May 22 to 23, 2002, pages 1316 to 1319, 2002, or with respect to a predetermined reference position, that is to say to carry out a self-organization process.

A processor element can thus very easily determine its position within a surface without any additional external information, even when a textile fabric structure is cut to a predetermined shape, during the process of which processor elements or coupling lines between the individual microelectronic components may be destroyed or removed by the cutting process.

For self-organization of the processor elements for the mass market, this therefore allows a textile fabric structure to be configured in a very simple and cost-effective manner for the textile fabric structure to be cut to a predetermined, desired shape for laying of the textile fabric structure and, despite the additional electronics integrated in the textile fabric structure, not to have to be concerned about the positions at which the processor elements are arranged within the surface that is covered by them in order that each processor element within the textile fabric structure can be addressed uniquely.

A textile fabric structure as described above and on which surface paneling is fixed is provided for a surface paneling structure.

One aspect of the invention can be regarded as being that the regular coupling topology with a degree greater than unity within the processor arrangement allows the integration complexity and hardware complexity for the processor elements with the processors in the processor arrangement to be reduced such that the number of communication interfaces required is now reduced in comparison to the previous, for example, four or six bidirectional communication interfaces (see FIG. 2), so that there is no longer any need to provide additional communication interfaces in a processor element, in addition to the communication interfaces which are already provided by the processor itself.

In particular, only two communication interfaces are now required, instead of the originally required four or six communication interfaces. Many modern commercially available microcontrollers, that is to say processors, have two communication interfaces.

By way of example, a number of microcontrollers from the Infineon™ Company, for example the XC161 or XC164 microcontrollers, have two standardized communication interfaces. The processor elements can thus be produced considerably more cost-effectively and with fewer components without any need to dispense with standardized communication, that is to say without dispensing with the use of a standardized communication protocol.

According to one embodiment of the invention, there is no longer any need to use a point-to-point communication link, such as that according to the prior art, for coupling two processors which are physically arranged directly adjacent to one another, as was corresponded to a coupling topology of a degree equal to unity, but a regular coupling topology with a degree greater than unity is used, in one case, a regular bus coupling topology or a regular ring coupling topology.

In general, according to embodiments of the invention, any regular higher-order (greater than unity) coupling topology can be used for coupling the processors which are arranged directly adjacent to one another within the processor arrangement.

This obviously means that the reduction in the number of communication interfaces that is required is achieved by changing from a point-to-point communication link to a regular higher-degree (higher-order) topology, in each case with a maximum of four subscribers. In this case, the requirement for local communication between processors which are arranged physically directly adjacent to one another is still satisfied, and that the grid structure of the communication link lines which were provided for the original arrangement can be transferred without any change, so that the fundamental arrangement can be used as described in T. F. Sturm, S. Jung, G. Stromberg, A. Stohr, A Novel Fault Tolerant Architecture for Self-Organizing Display and Sensor Arrays, International Symposium Digest of Technical Papers, Volume XXXIII, Nr. II, Society for Information Display, Boston, Mass., May 22 to 23, 2002, pages 1316 to 1319, 2002.

According to one refinement of the invention, one particularly simple, and thus cost-effective regular coupling topology of degree greater than unity which is robust with regard to errors and faults, is a regular bus coupling topology on the basis of which the processors which are physically arranged directly adjacent to one another are coupled to one another.

According to one alternative refinement of the invention, a simple and thus cost-effective regular coupling topology of degree greater than unity for coupling of the processor which are physically arranged directly adjacent to one another is a regular ring coupling topology.

One development of the invention provides for the regular bus coupling topology to be designed on the basis of one of the following communication interface standards:
Serial Parallel Interface (SPI),
Controller Area Network interface (CAN interface), or
an I²C interface as described in C. Fenger, Phillips Semiconductors, Integrated Circuits, Application note, AN168: The I²C Serial Bus: Theory and Practical Consideration Using Philips Low-Voltage PCF84Cxx and PCD33xx μC Families, December 1988.

In other words, according to one refinement of the invention, an SPI bus, a CAN bus or an 1²C bus is provided in order to produce the regular coupling topology of degree greater than unity.

The processors may be arranged in rows and columns in the form of a matrix, or alternatively in the form of a hexagonal structure.

According to one refinement of the textile fabric structure, the electrically conductive threads are designed such that they can be used to supply power to the two or more processors and/or actuators.

According to another refinement of the invention, the conductive data transmission threads are electrically conductive.

Alternatively, the conductive data transmission threads may be optically conductive.

In one embodiment each processor element from the two or more processor elements is coupled to all of the adjacent processor elements by means of the conductive threads and the conductive data transmission threads, that is to say in a regular rectangular grid to in each case four adjacent processor elements.

At least one sensor is in one case coupled to the two or more processors. A sensor such as this may be a pressure sensor, a heat sensor, a smoke sensor, an optical sensor or a noise sensor.

In one development, the textile fabric structure has at least one imaging element and/or a sound wave producing element and/or a vibration producing element, which is coupled to at least some of the two or more processor elements.

This means that the textile fabric structure has at least one actuator integrated in it. The actuator is, for example an imaging unit or a sound-producing unit, in one case, a liquid crystal display unit or a polymer electronic display unit, in general any type of display unit, or a loudspeaker which produces a sound wave, in general any element which produces an electromagnetic wave. One further possible actuator that is provided is a vibration-producing element.

According to another refinement, the two or more processors and/or sensors and/or actuators in the textile fabric structure are designed such that messages are interchanged between the first processor element and a second, adjacent processor element in the textile fabric structure in order to determine the respective distance of a first processor element from a reference position. Each message contains distance information which indicates the distance of a processor element that is sending the message or of a processor element that is receiving the message from the reference position. Furthermore, the two or more processor elements are designed such that their own distance to the reference position can be determined or can be stored from the distance information in a received message.

The surface paneling structure is in one case in the form of a wall paneling structure, floor paneling structure or ceiling paneling structure.

The surface paneling structure may have a textile through which electrically conductive wires pass uniformly, at least over subareas of the textile fabric structure.

The textile through which electrically conductive wires pass may be used in order to avoid “electrosmog” in the vicinity of people. This allows the “electrosmog” to be shielded. In this case, however, care should be taken to ensure that, if appropriate, specific areas, for example areas above capacitive sensors, are not covered by the shield.

The invention is suitable, for example, in the following application areas:
building automation, in particular in order to improve the building convenience,
alarm systems with the position, and optionally, the weight of an entry person or object being determined,
automatic visitor guidance in exhibition sites or in a museum,
for a control system for an emergency situation, for example in an aircraft or in a train, in order to indicate an emergency escape route to passengers,
in textile concrete structures in which textile fabric structures can be used to detect possible damage,
gathering information for statistical analysis, as to which areas in a company are visited by customers, and for how long.

In addition to a basic fabric which is in one case composed of plastic fibers (electrically non-conductive threads), a textile fabric structure according to one embodiment of the invention contains conductive threads, in one case conductive warp and weft threads, which are composed of metal wires, for example copper, polymer filaments, carbon filaments or other electrically conductive wires. If metal wires are used, in one case a coating composed of more noble metals, such as gold or silver, is used as corrosion protection against moisture or corrosive media. Another possibility is to isolate metal threads by the application of an insulating varnish, for example polyester, polyamidimide, or polyurethane.

In addition to electrically conductive fibers, optical waveguides composed of plastic or glass may be used as data transmission threads.

The basic fabric of the textile fabric structure is in one case produced with a thickness which is matched to the thickness of the processor element to be integrated in it, which are also referred to in the following text as microprocessor modules, for example sensors, light-emitting diodes and/or microprocessors. A sensor may, for example, be a pressure sensor, a heat sensor, a smoke sensor, an optical sensor or a noise sensor. The separation between the optically and/or electrically conductive fibers is in one case chosen such that this matches the connection grid of the processor elements to be integrated.

Even when carpet arrangements are described in the following exemplary embodiments, the invention is not restricted to a carpet, but can be used for any element that is suitable for surface covering or surface cladding, in general for any processor arrangement in which a processor is associated with a sensor and/or an actuator.

The textile fabric structure according to the invention with integrated microelectronics, processor units and/or sensors and/or actuators, for example small indicator lamps, is intrinsically fully operational and can be fixed under different types of surface panelings. Items such as these may include, for example, non-conductive textiles, floor coverings such as carpets, parquet flooring, plastic, drapes, roller blinds, wallpaper, insulating mats, tent roofs, plaster layers, paintwork and textile concrete. These items are, in one case, fixed by means of adhesion, lamination or vulcanization.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 illustrates a plan view of a tile arrangement according to a first exemplary embodiment of the invention.

FIGS. 2a to 2c illustrate plan views of tiles according to embodiments of the invention, a rectangular tile (FIG. 2a), a triangular tile (FIG. 2b) or a hexagonal tile (FIG. 2c);

FIG. 3 illustrates a plan view of a tile in the tile arrangement illustrated in FIG. 1.

FIG. 4 illustrates a schematic plan view of a tile arrangement according to the first exemplary embodiment of the invention, with a central control computer.

FIG. 5 illustrates a plan view of a tile arrangement according to a second exemplary embodiment of the invention.

FIG. 6 illustrates a plan view of a hexagonal tile.

FIGS. 7a and 7b illustrate a directional graph (FIG. 7a) and a non-directional graph (FIG. 7b).

FIG. 8 illustrates a directional tree.

FIGS. 9a and 9b illustrate a sketch of a processor arrangement, in the form of a non-directional graph (FIG. 9a) and a directional graph (FIG. 9b);

FIG. 10 illustrate a sketch of different routing paths as a directional tree with an input node as the root.

FIG. 11 illustrates a stretch of an optimized routing tree.

FIGS. 12a to 12j illustrate a sketch of the routing tree from FIG. 11 at different drive points in time.

FIGS. 13a to 13f illustrate a sketch of the routing tree from FIG. 11 at different drive points in time.

FIG. 14 illustrates a plan view of two horizontal tiles, illustrating the bidirectional message interchange between the two tiles.

FIG. 15 illustrates a sketch of an incoherent tile.

FIG. 16 illustrates a sketch of a coherent tile while measurement coherence messages are being sent.

FIG. 17 illustrates a sketch of a tile which is used as the basis to explain the sending of measurement position messages.

FIG. 18 illustrates a sketch of a tile arrangement whilst the positions of the individual tiles within the tile arrangement have been found.

FIG. 19 illustrates a sketch of a tile, which will be used as the basis for explaining the sending of a measurement distance message.

FIG. 20 illustrates the tile arrangement once the distance determination process has been carried out, with the tile arrangement having a large number of input processor units at the lower edge of the tile arrangement.

FIG. 21 illustrates a tile arrangement after the distance determination process has been carried out, with every third tile in the lowermost row of the tile arrangement each being associated with a reference position.

FIG. 22 illustrates a sketch of a tile which will be used as the basis to explain the reception and the transmission of measurement organize messages.

FIG. 23 illustrates a sketch of a tile which will be used as the basis for illustrating the organization sequence for sending a measurement channel message in an even-numbered column within the tile arrangement.

FIG. 24 illustrates a sketch of a tile which will be used as the basis to illustrate the organization sequence for transmission of a measurement channel message in an odd-numbered column within the tile arrangement.

FIG. 25 illustrates a sketch of a number of tiles, which will be used as the basis to explain the organization and the message interchange via channels which couple the communication interfaces of the tiles to one another.

FIG. 26 illustrates a tile arrangement once a regular backward organization process has been carried out, for the situation where information can be supplied or sent from or to a portal processor for all of the tiles in the lowermost row of the tile arrangement.

FIG. 27 illustrates a tile arrangement after a regular backward organization process has been carried out, for the situation where information can be supplied or sent from or to a portal processor for every third tile in the lowermost row of the tile arrangement.

FIG. 28 illustrates a sketch of a processor unit, which will be used as the basis to explain the reception and transmission of measurement count nodes messages.

FIG. 29 illustrates a sketch of a tile, which will be used as the basis to explain the reception and transmission of measurement node size messages.

FIG. 30 illustrates the tile arrangement once the process of determining the throughput of the tiles has been carried out, for the situation where information can be supplied or sent from or to a portal processor for all of the tiles in the lowermost row of the tile arrangement.

FIG. 31 illustrates the tile arrangement after the process of determining the throughput of the tiles has been carried out, for the situation where information can be supplied or sent from or to a portal processor for every third tile in the lowermost row of the tile arrangement.

FIG. 32 illustrates a sketch of a tile, which will be used as the basis to explain the transmission of measurement color distance messages;

FIG. 33 illustrates a sketch of a tile, which will be used as the basis to explain the reception and the transmission of measurement block token messages.

FIG. 34 illustrates a sketch of a tile, which will be used as the basis to illustrate the reception of a measurement token message by an “uncolored” tile.

FIG. 35 illustrates the tile arrangement once the process of determining meandering channels and the tile arrangement has been carried out and tokens have been allocated, for the situation where information can be supplied or sent from or to a portal processor for all the tiles in the lowermost row of the tile arrangement.

FIG. 36 illustrates a sketch of a tile, which will be used as the basis to explain the reception and the transmission of measurement delete channel messages.

FIG. 37 illustrates a sketch of a tile, which will be used as the basis to explain the reception and the transmission of measurement column organize messages.

FIG. 38 illustrates the tile arrangement once a reorganization process has been carried out, for the situation where information can be supplied or sent from or to a portal processor for every third tile in the lowermost row of the tile arrangement.

FIG. 39 illustrates the tile arrangement once a reorganization process has been carried out, for the situation where information can be supplied or sent from or to a portal processor for all of the tiles in the lowermost row of the tile arrangement.

FIG. 40 illustrates a sketch of a processor unit, which will be used as the basis to explain the initialization of the input tile color by means of a measurement color distance message.

FIG. 41 illustrates the tile arrangement after a reorganization process has been carried out, for a weight of g=0, for the situation where information can be supplied or sent from or to a portal processor for all of the tiles in the lowermost row of the tile arrangement.

FIG. 42 illustrates the tile arrangement once a reorganization process has been carried out, for a weight of g=□, for the situation where information can be supplied or sent from or to a portal processor for all of the tiles of the lowermost row of the tile arrangement.

FIG. 43 illustrates a sketch of a tile, which will be used as the basis to explain the reception and the transmission of measurement numbering messages.

FIG. 44 illustrates a sketch of the tile arrangement once a renumbering process has been carried out, for the situation where information can be supplied or sent from or to a portal processor for all of the tiles in the lowermost row of the tile arrangement.

FIG. 45 illustrates the tile arrangement once a numbering process has been carried out, for the situation where information can be supplied or sent from or to a portal processor for every third tile in the lowermost row of the tile arrangement.

FIG. 46 illustrates a routing table based on one exemplary embodiment of the invention.

FIG. 47 illustrates a sketch of a tile arrangement, which will be used as the basis to explain the routing and the display of data.

FIG. 48 illustrates a sketch of a tile, which will be used as the basis to explain the reception and transmission of measurement retry messages.

FIG. 49 illustrates an overview of the messages that are used.

FIG. 50 illustrates a schematic circuit diagram of a tile based on one exemplary embodiment of the invention.

FIG. 51 illustrates a plan view of a plug connector for a tile based on one exemplary embodiment of the invention.

FIGS. 52a and 52b illustrate a cross-section view of a plug connector for a tile and of a tile connecting piece, based on one exemplary embodiment of the invention.

FIG. 53 illustrates a processor arrangement based on another aspect of the invention.

FIG. 54 illustrates an enlarged detail A of the processor arrangement illustrated in FIG. 53.

FIG. 55 illustrates a processor arrangement based on another aspect of the invention.

FIG. 56 illustrates a sketch of a processor element, as is provided in the exemplary embodiments according to the invention.

FIG. 57 illustrates a processor arrangement based on another aspect of the invention.

FIG. 58 illustrates a processor arrangement based on a fourth exemplary embodiment of the invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

FIG. 1 illustrates a tile arrangement 100 having a large number of rectangular tiles, which are arranged in rows and columns in the form of a matrix and which are coupled to one another (as will be explained in more detail in the following text) via data transmission interfaces, with one tile 101 in each case being coupled to a tile 101 which is arranged directly adjacent to it.

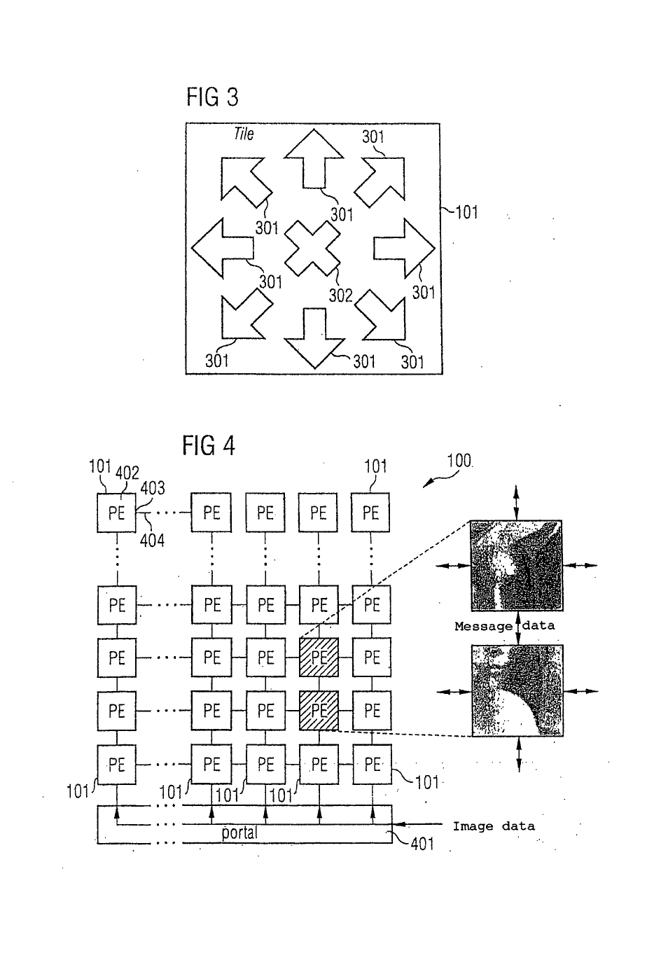

Each of the tiles 101 is physically identical, as is illustrated in the enlarged illustration in FIG. 3.

FIG. 3 illustrates the tile 101 with a large number of display elements 301, 302, in this exemplary embodiment nine such elements, of which eight display elements 301 are arranged in the form of an arrow and one, the display element 302 arranged in the center of the tile 101, is in the form of a cross. The display elements 301, 302 are used to indicate a route which a user who is passing over the tile arrangement 100 should follow to reach a desired, predetermined destination. The direction arrow display elements 301 have one or more corresponding background lighting systems, which each individually drive one or more of the arrow-shaped display elements 301, thus in each case illuminating one or more of the display elements 301.

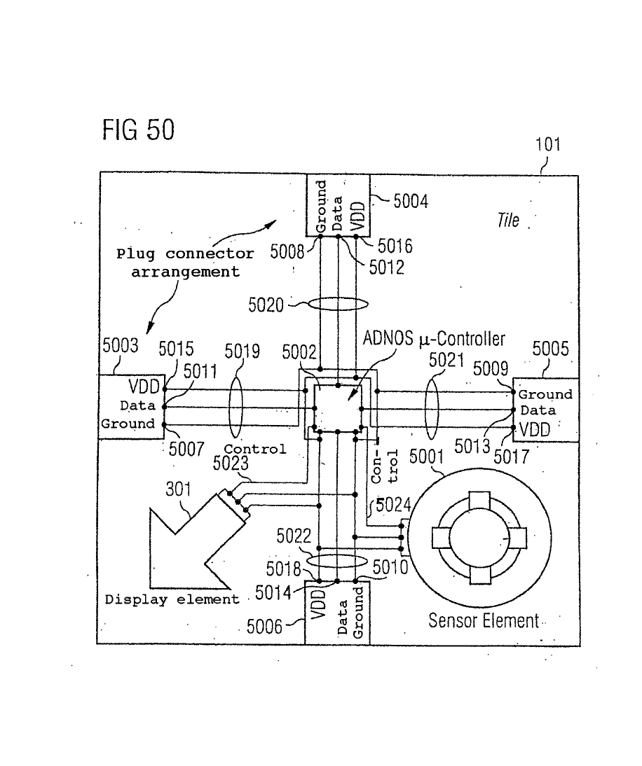

In addition to the display units, generally an imaging unit, the tile 101 according to this exemplary embodiment also has a sensor element 5001, as illustrated in the circuit diagram in FIG. 50, which, according to this exemplary embodiment, is in the form of a pressure sensor.

Each tile 101 also has a processor 5002, on the basis of this exemplary embodiment, a microprocessor, as well as in each case one plug connector 5003, 5004, 5005, 5006 on each side of the rectangular tile 101, assuming that the tile 101 has a rectangular shape.

The plug connectors 5003, 5004, 5005, 5006 have a respective ground connection 5007, 5008, 5009, 5010, as well as a data transmission connection 5011, 5012, 5013, 5014 as a data transmission interface, with the interface being in the form of a bidirectional communication interface, as well as an electrical power supply connection 5015, 5016, 5017, 5018, to which the supply voltage V_{DD} is applied.

The electrical power supply connection 5015, 5016, 5017, 5018 is coupled to the processor 5002 in the same way as each data transmission connection 5011, 5012, 5013, 5014 and each ground connection 5007, 5008, 5009, 5010.

According to this exemplary embodiment of the invention, the individual components of the tile 101 are coupled via electrical lines 5019, 5020, 5021, 5022. Furthermore, the microprocessor 5002 is coupled to the display elements 301, 302 via a first control line 5023, via which the respective display element 301, 302 is supplied with control signals, and is coupled to the sensor element 5001 via a second control line 5024, by means of which data detected by the sensor element 5001 is passed from the sensor element 5001 to the processor 5002.

Each plug connector 5003, 5004, 5005, 5006 is in each case arranged on the lower face of the tile 101, and is also referred to in the following text as a docking bay.

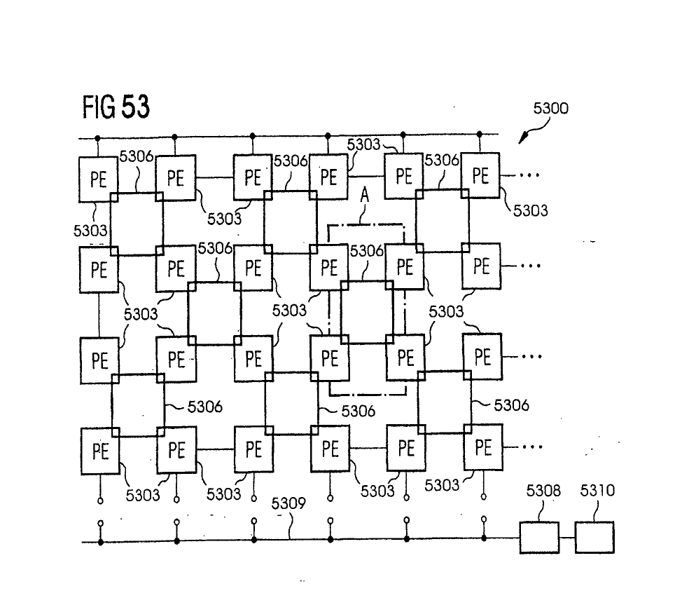

Each plug connector 5003, 5004, 5005, 5006 on the tile 101 can be electrically and mechanically connected to its respective mating piece on the tile 101 physically arranged immediately adjacent to it via a tile connecting piece 5210 whose cross section is illustrated in FIG. 52b.

According to this exemplary embodiment, the arrangement of the plug connectors is rotationally symmetrical for multiples of 90°.

The arrangement described above can be applied or transferred directly to any desired shape of a tile or wall tile 101, although the arrangement of the plug connectors on the respective faces of the tiles 101 and the corresponding wiring must be matched to the respective shape; for example, in the case of a hexagonal tile 101, a plug connector is arranged on each of the respective faces, that is to say there are a total of six plug connectors. In the case of a tile having a triangular shape, three plug connectors are arranged in a corresponding manner on the respective faces of the tile 101.

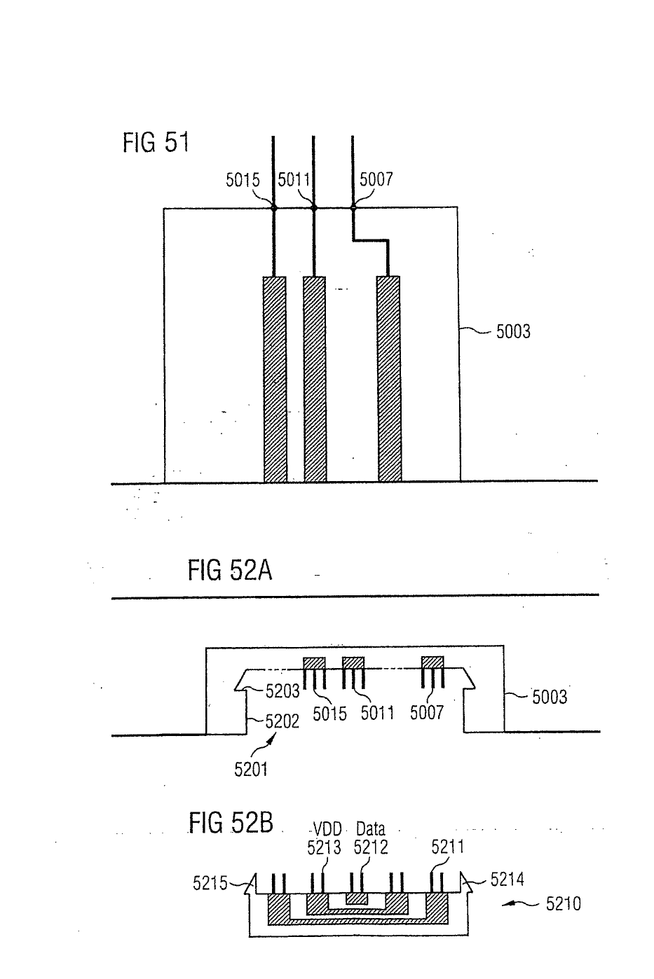

FIG. 51 illustrates an enlarged illustration of the plug connector 5003 with the ground connection 5007, the data transmission connection 5011 and the electrical power supply connection 5015.

Two directly opposite docking bays are each connected to one another by means of the tile connecting piece 5210, whose cross-section view is illustrated in FIG. 52B. During the course of laying tiles or wall tiles, that is to say during the installation process, the tile connecting piece 5210 is fitted first of all, for example by introducing it into the plaster or a tile grid, and the respective docking bay of the tile 101 is then plugged onto the tile connecting piece 5210.

This situation is illustrated in FIG. 52A and FIG. 52B, which illustrates a cross-section view of the plug connector 5003 with the respective plug connections 5007, 5011, 5015 and the corresponding connections of the tile connecting piece 5210, a corresponding ground connection 5211, a corresponding data transmission interface 5212, and a corresponding electrical power supply connection 5213.

The plug connector 5003 has a cavity 5201 in which the connections 5007, 5011, 5015 are arranged and formed. Cutouts 5203 in the form of lugs are provided on the side walls 5202 of the cavity 5201, in which elements 5214, 5215 in the form of lugs on the tile connecting piece 5210 engage as a click-action fastener, thus mechanically coupling the plug connector 5003 to the tile connecting piece 5210.

Instead of the connections 5007, 5011, 5015 which are permanently fitted in the tile connecting piece 5210, it is also possible to alternatively provide flexible cables, which are coupled to corresponding mating pieces of the tile connecting piece 5210.

The lighting elements which are illustrated in the tiles 101 in FIG. 3 may be in the form of a light-emitting diode or even a screen of any desired complexity, and may be used to define fixed predetermined routes or dynamic routes. In an exhibition or while passing around a museum, for example it is possible to indicate the route to a subsequent attraction, in which case the entire system can use the respective sensor element 501 to determine the position of the respective visitor, and can thus give him individual direction instructions.

In one refinement of the invention, a tile may also have a radio transmitting/receiving system, via which a user (for example using a radio transmitter) transmits his identity, which is received by the radio receiver in the tile 101, thus allowing user-specific guidance through a museum or through an exhibition as a function of the respective user identity.

The sensor may be in the form of a pressure sensor with weight determination, in the form of an inductive sensor, in the form of a capacitive sensor (Edison sensor), in the form of an optical sensor or in the form of a moisture sensor.

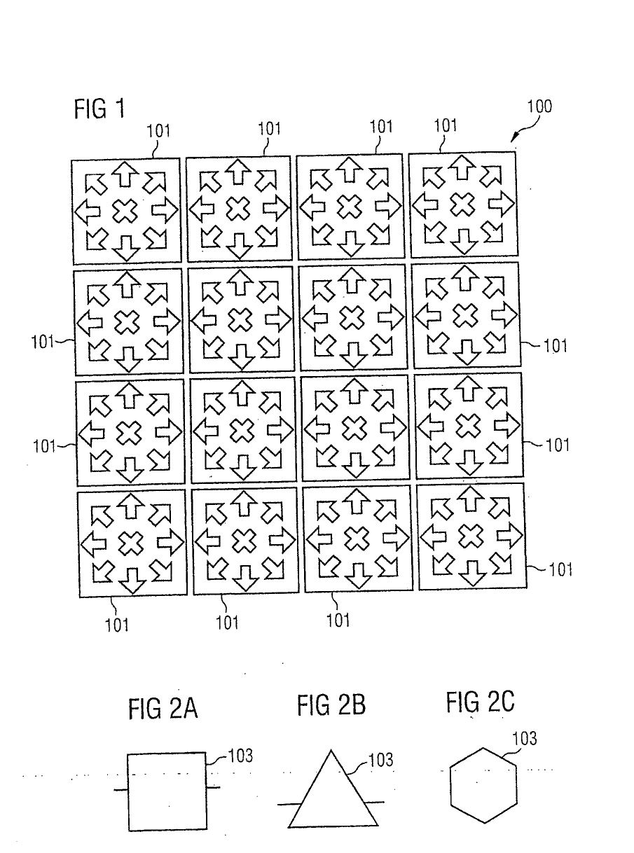

The individual tiles 101 according to one embodiment of the invention may be designed in any desired way, for example being rectangular as illustrated in FIG. 2a, triangular as illustrated in FIG. 2b, or hexagonal as illustrated in FIG. 2c.

FIG. 4 illustrates a schematic view of the tile arrangement 100 with a large number of tiles 101 and a tile data portal 401 which is arranged on one side of the tile arrangement 100, with at least one portal processor for introducing information to the processors for the respective tiles 101 in the tile arrangement 100.

The portal processor is coupled to at least one tile 101 and uses the respective data transmission interface to supply the desired data to this tile 101 or for this tile 101 to check the desired data.

According to this exemplary embodiment, the respective portal processor for the tile data portal 401 has no information whatsoever about the size and configuration of the tile arrangement 100.

In addition, the individual processor units for the tiles 101 have no information whatsoever about the respective orientation of the tiles at the start of the method, that is to say the alignment, or their physical position within the tile arrangement 100.

In an initialization phase, which will be explained in detail in the following text (before the initial use of the tile arrangement 100 or after information that is stored in the tile arrangement 100 has been reset), the portal processor for the tile portal 401 initiates a self-organization process for the processor arrangement, as will be explained in more detail in the following text.

In the course of the self-organization process for the tile arrangement 100, the tiles 101 in the tile arrangement 100 learn their position and alignment as well as information paths for image construction, that is to say for supplying information to be displayed to the respective display units which are intended to actually display the respective information.

This learning process is carried out using messages which are interchanged between processor units of respectively mutually adjacent tiles 101 in the tile arrangement 100. Some of the knowledge that is learned is passed on again to the exterior, that is to say to the tile portal 401, to be precise to the extent as is subsequently required by the tile portal 401 in order to supply the image information on the correct routes and in the correct sequence to the tile arrangement 100 in order to display the respective information to be displayed.

The nature of the information to be displayed must be taken into account in the procedure for information distribution within the tile arrangement 100.

In the course of the information distribution process, each processor for a tile 101 is addressed individually by the portal processor for that tile portal 401. This leads to the information being routed as required for information display purposes to the appropriate tiles 101 and thus to the appropriate processor units within the tile arrangement 100. According to one embodiment of the invention, the following special features of the routing problem are taken into account for routing of information:
routing paths are defined only between the portal processor of the tile portal 401 and the individual processors of the tiles, that is to say the processor units of the tile arrangement 101, but not between the tiles 101.
A uniform routing resource is provided, that is to say one and only one image data item should be transmitted to each processor per digitized image to be displayed.
No global knowledge is assumed about the configuration of the network, that is to say the networking of the individual tile processors within the tile arrangement 101. The choice of the routing paths within the tile arrangement 100 is made on the basis of local information, which is interchanged between the individual tile processors, using electronic messages.

Thus, according to one embodiment of the invention, a distinction is drawn between two phases in the course of use of a tile arrangement 100 according to the invention:

In a first phase, the so-called self-organization phase, the following processes are carried out:
self-identification of the local positions of the individual tile processors within the tile arrangement, and thus the overall shape of the tile arrangement;
self-organization of routing paths, starting from the portal processor, that is to say the processor of the tile portal 401 for each tile processor in the tile arrangement 100, in such a way that each tile processor can be supplied with an electronic message from the processor for the tile portal 401 within a predetermined maximum number of clock cycles.

In a second phase, the actual use of the tile arrangement 100 for the purposes of detection and/or display of information, the data is transmitted from or to the portal processor to the tile processors, thus resulting in the information to be displayed being built up in the tile arrangement 100.

In the situation as illustrated in FIG. 4, in which the tile processors 402 have a rectangular shape, in one case, a square shape, they are each coupled to the tile processor 402 that is directly adjacent to a respective tile processor 402 via one side of the quadrilateral via one of the bidirectional communication interfaces 403 (of which four are in each case thus provided) per tile processor 402 and, furthermore, via electrical lines 404.

In other words, this means that this in each case allows messages to be interchanged between two tile processors which are directly adjacent to one another, but this does not allow direct interchange of messages over a longer distance than the direct neighborhood of a tile processor 402.

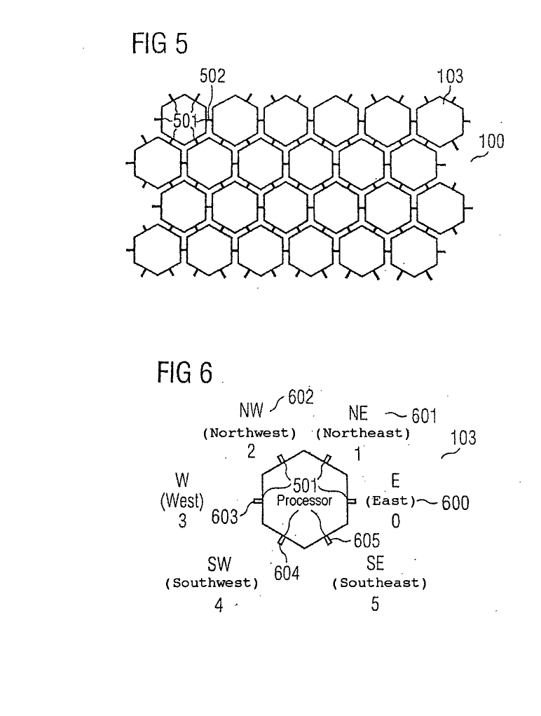

FIG. 5 illustrates another exemplary embodiment, in which each tile 101 has a hexagonal shape, and six bidirectional communication interfaces 501 are provided per tile 101, likewise on each side, that is to say side edge, of the respective tile 101. This means that, according to this exemplary embodiment, each tile 101 and thus each tile processor has six adjacent tile processors, to which the respective tile 101 is coupled for the interchange of electronic messages via a bidirectional communication interface 501 and an electrical line 502.

In order to simplify the description of the invention, the following text will describe only the situation in which a tile 101 has a hexagonal shape, but without any restriction to generality.

The tile arrangement 100 thus has three types of individual components:
tiles 101 which are each associated with up to six bidirectional communication interfaces 501 and electrical lines 502, and
bidirectional links, which are also referred to in the following text as a bidirectional communication interface 501 and the electronic line 502 which is associated with the respective communication interface 501, which in each case couple to one another two tiles 101 or one tile 101 and the portal processor, and
tile connecting pieces.

The hexagonal tile 101 may have six different alignments, as is illustrated in FIG. 6.

As can be seen from FIG. 6, the individual connections, that is to say therefore including the individual communication interfaces 501, have already been oriented during the self-organization phase, as will be explained in more detail in the following text. According to this exemplary embodiment, the connections are numbered successively and, in order to assist understanding, are identified by points of the compass, with the following nomenclature being used according to this exemplary embodiment:
a first alignment 0 (east) (reference symbol 600), or in other words an alignment to the right,
a second alignment 1 (north-east) (reference symbol 601), or in other words an alignment up and to the right,
a third alignment 2 (north-west) (reference symbol 602), or in other words an alignment up and to the left,
a fourth alignment 3 (west) (reference symbol 603), or in other words an alignment to the left,
a fifth alignment 4 (south-west) (reference symbol 604), or in other words an alignment down and to the left, and
a sixth alignment 5 (south-east) (reference symbol 605), or in other words an alignment down and to the right.

This exemplary embodiment is based on the assumption that the portal processor for the tile portal 401 has electrical couplings to tiles 101 on only one side of the tile arrangement 100.

By definition, this is the lower side of the tile arrangement 100, that is to say, as can be seen, the south side, with the couplings likewise by definition running over the south-west side, that is to say over the fifth alignment direction of the respective tiles 101.

In this context, it should be noted that both the positioning and the alignment of the individual points at which information is introduced to the tiles 101 in the tile arrangement 100 as well as the shape and the alignment of the individual tiles 101 in the tile arrangement 100 are fundamentally as required.

In different embodiments of the invention, the portal processor
is electrically coupled to all of the tile processors of the tiles in the lowermost row in the form of a matrix, that is to say tile processors arranged in rows and columns in the tile arrangement 100, or
to tile processors 101 for the tiles in the lowermost row of the tile arrangement with a predetermined, regular separation, that is to say a periodic separation, that is to say, for example every third, fifth, tenth, etc., tile processor within the lowermost row of the tile arrangement 100.

Once the manufacture of the tile arrangement 100 has been completed, the portal processor 401 admittedly knows the number of its connections to the tile processors 402, or in other words the number of introduction points for supplying information to tile processors 402 within the tile arrangement 100, but does not necessarily know the shape and the configuration of the tile arrangement 100, that is to say the actual shape and arrangement of the tiles 101 within the tile arrangement 100.

In this context, it shall be noted that, in particular, direction details, for example the south side, need not necessarily represent a straight line within the tile arrangement 100.

For the method elements which will be explained in the following text, all that is necessary is to ensure that the individual links between the portal processor and the tile processors 101 should always be made at the same point, according to this exemplary embodiment via the south-west side 604.

The individual tile processors 101 or the links, which are both referred to as a generic term as individual components of the processor arrangement, may assume the following states:

1. Fault-Free:

The respective component of the tile arrangement is operating without any restrictions.

2. Defective:

The respective component in the tile arrangement has failed completely. If the component is a processor unit, then all of the links to this processor unit must likewise be declared as being defective.

3. Unstable:

The component has partial failures, for example one direction of a bidirectional link between the respective processor unit is operating only at times (that is to say it has an intermittent contact or is operating methodically incorrectly, for example a processor which is sending an incorrect message).

In order to simplify the description of the invention, the following text will not consider the third state, that is to say a component is assumed in the following text to be either fault-free or defective. On the basis of these exemplary embodiments, it is thus irrelevant whether a component does not exist owing to a specific form of the tile arrangement (that is to say, for example, a display unit film which is in the form of a triangle), or whether the respective component has become defective owing to a manufacturing fault or as a result of wear.

The clocking of the overall system, that is to say of the overall tile arrangement 100, will be considered in the following text with regard to the passing on of information, which will be explained in more detail in the following text, that is to say the sending of electronic messages between two tile processors 101 within the tile arrangement 100, or from the portal processor to a tile processor at an introduction point to the tile arrangement 100.

Each tile processor in the tile arrangement 100 is designed such that it can carry out the following actions within one clock cycle:
read one or more electronic messages which are present on one or more links, that is to say via one or more bidirectional communication interfaces of the respective tile processor and which have been sent from an adjacent tile processor in a previous clock cycle.
Process the received message.
If appropriate, send one or more messages via one or more links and thus via one or more bidirectional communication interfaces of the tile processor which can be received by an adjacent tile processor in a subsequent clock cycle, that is to say the next clock cycle.

An electronic message can thus be transmitted only from one tile processor to an adjacent tile processor within one clock cycle.

However, in this context, it should be noted that, according to one embodiment of the invention, there is no need for the tile processors to have a global, common clock, that is to say a clock which is provided for the entire processor arrangement 100, although this is assumed in the following text in order to simplify the description of the invention.

In order to assist understanding of the procedure according to the invention, the following text explains principles of the mathematical modeling of the tile arrangement.

The tile processors and the tile portal 401 are modeled jointly in the following text as a directional graph as well as routing paths as a directional tree.

The trace of routing is thus a discrete optimization problem.

Definition 1 (Directional Graph, Non-Directional Graph)

(i)

Assume a set V and a set E. Then:
g:E→V²=V×V
a map with the components
g⁻:E→V and g⁺:E→V,
that is to say
g:E→V²,
e [symbol] (g⁻(e),g⁺(e)),
so that the tuple
(V,E,g)
is a directional graph with a corner set (node set) V, edge set E and incidence map g. g⁻(e) is the initial corner of the edge e ε E and g⁺(e) is the terminating corner of the edge e ε E.

(ii)

Assume a set V and a set M. Then consider the equivalence relationship
α:={((x, y), (y, x)) ε V²×V²; where x, y ε V}⊂V²×V²
with the equivalence classes
[x, y]:={(x, y), (y, x)}, for all x, y ε V.
With a map
u:M→V²/α={[x, y]; x, y ε V}
the tuple
(V,M,u)
is a non-directional graph with the corner set (node set) V, the edge set M and the incidence map u.

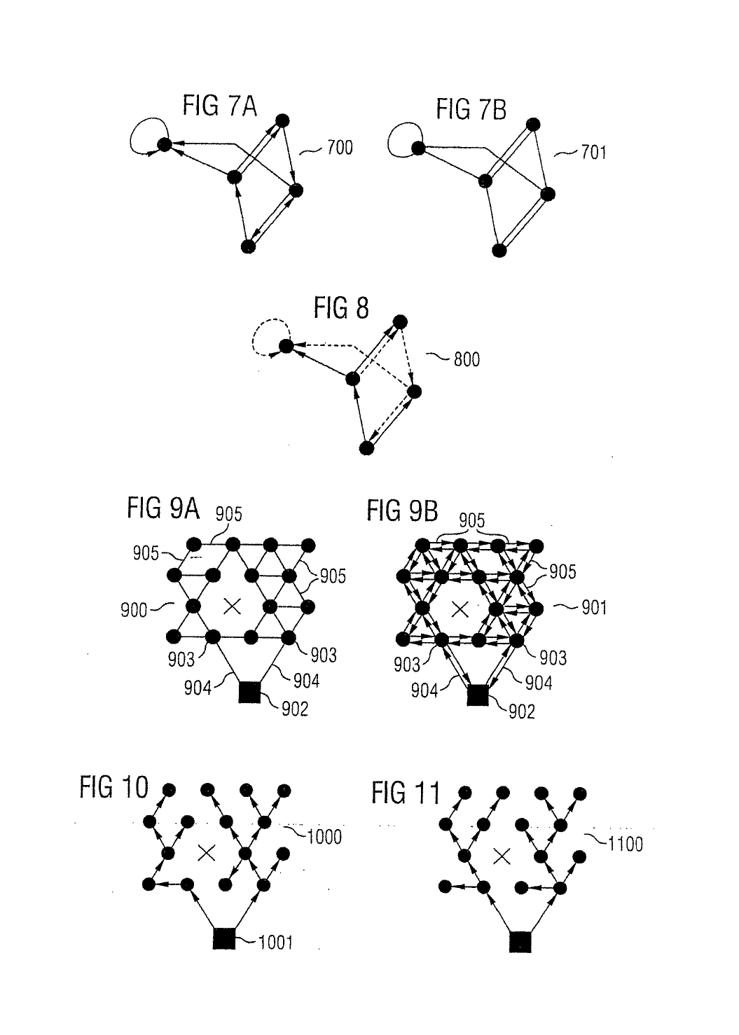

FIG. 7a illustrates a directional graph 700, and FIG. 7b illustrates a non-directional graph 701.

Definition 2 (Terminated Edges, Initiated Edges)

Assume that (V,E,g) is a directional graph, and v ε V. Eₜₑᵣₘ(v) is then the set of the edges terminated by v, that is to say:
Eₜₑᵣₘ(v):={e ε E; g⁺(e)=v},
and Eᵢₙᵢₜ(v) is the set of the edges initiated by v, that is to say:
Eᵢₙᵢₜ(v):={e ε E;g⁻(e)=v}.
Definition 3 (Path in a Directional Graph)

Assume that (V,E,g) is a directional graph, K ⊂ E.

(i)

For a, b ε V and n ε N define

$${Γ}_{K}^{n} ( a , b ) := \{ \begin{matrix}( {k}_{1} , … , {k}_{n} ) {∈}^{n} {K}^{n} ; a = {g}^{-} ( {k}_{1} ) {g}^{+} ( {k}_{n} ) = b , \\ {g}^{+} ( {k}_{i} ) = {g}^{-} ( {k}_{i + 1} ) for i = 1 , … , n - 1 , \\ \vert \{ a , {g}^{+} ( {k}_{1} ) , … , {g}^{+} ( {k}_{n} ) \} \vert = n + 1\end{matrix} \}$$

as the set of all paths from a to b of length n with edges K
(Γ_{K}ⁿ(a, b)={ }, if no such path exists).

(ii)

For a, b ε V define

$${Γ}_{K} ( a , b ) := {⋃}_{n ∈ N} {Γ}_{K}^{n} ( a , b )$$

as the set of all paths from a to b with edges of K.
Definition 4 (Directional Tree)

Assume that (V, E, g) is a directional graph V≠0. (V, E, g) is a directional tree, provided there is a w ε V such that
|Γ_{E}(w,v)|=1, for all v ε V\{w}
and for all K ⊂ E, K≠E
|Γ_{E}(w,v)|=0, for at least one v ε V\<w>.

This means that there is one and only one path from w to each corner v≠w, and the edge set cannot be reduced in size. The unique corner w is referred to as the root of the directional tree.

The second condition in the above definition 4 guarantees the uniqueness of the root, which would otherwise not exist, and prevents the existence of “superfluous” edges in the tree.

FIG. 8 illustrates one example of a directional tree 800 as a part of the directional graph sketched in FIG. 7a.

Lemma 5 (Characteristics of a Directional Tree)

Assume that (V, E, g) is a directional tree. Then, for all a, b ε V
|Γ_{E}(a,b)|+|Γ_{E}(b,a)≦1.
Definition 6 (Path Length, Throughput)

Assume that (V, E, g) is a directional tree with the root w ε V. Define

(i)

For each v ε V\{w}, assume that γ_{E}(v) ε Γ_{E}(w,v) is the unique path from w to v, that is to say
Γ_{E}(w,v)={γ_{E}(v)}.

(ii)

For each v ε V\{w} there is one n ε N for which
{γ_{E}(v)}=Γ_{E}(w,v)=Γ_{E}ⁿ(w,v)

Define |γ_{E}(v)|:=n as the path length of the path γ_{E}(v).

(iii)

Define |V|<∞ and all v ε V
d_{E}(v):=1+|{z ε V;Γ_{E}(v,z)≠{}}|ε N
as the throughput of the node v.
Definition 7 (Branch)

Assume that (V, E, g) is a directional tree. Define, for all v ε V
V_{E}(v):={v}∪{z ε V; Γ_{E}(v,z)≠{}}
as a branch of the node v.

The following lemma exists:

Lemma 8 (Power of the Branch)

Assume that (V, E, g) is a directional tree and v ε V. Then:
d_{E}(v)=|V_{E}(v)|.

The overall network of the tile arrangement 100 including the portal processor 401 is referred to in the following text as a graph. In order to model the fact that existing links between two nodes can always be passed through in two directions, which symbolizes a bidirectional communication, a non-directional graph will be considered first of all. An equivalent directional graph will then be derived, in order to define the routing.

Definition 9 (Display Graph)

Assume that (V, M, u) is a non-directional graph where

(i)
2≦|V|<∞,1≦|M|<∞,

(ii)

u injective (that is to say no digon)

(iii)
u(E)∩{[x,x]; x ε V}={} (that is to say no loops)

(iv)

Assume that w ε V is a prominent node and is called a portal (node).

Assume that (V, E, g) is the directional graph for which: for each m ε M consider new elements m⁻ and m⁺ such that
E:={m⁻; m ε M}∪{m⁺;m ε M}, |E|=2|M|.

Choose the map g such that
u(m)={g(m⁻), g(m⁺)}, for all m ε M.

If, in addition:

(v)
Γ_{E}(w,v)≠{} for all v ε V\{w} (that is to say cohesive),

then (V, E, g) is a display unit graph, which is also referred to in the following text as a display graph.

A corresponding non-directional graph 900 (see FIG. 9a) and the equivalent directional tile arrangement graph 901 (FIG. 9b) are illustrated in exemplary form in FIG. 9a and FIG. 9b.

According to this exemplary embodiment, a hexagonal 4×4 tile array with a defect is chosen. The above definition 9 is generally complied with. The networks under consideration have further restrictive characteristics, although these will initially be mentioned only briefly here:
with the exception of the portal node 902, the number of edges with which a node 903 can be associated as an initial (terminating) corner is restricted by a number q ε N. The analysis so far has been based on q=4 (orthogonal network) and q=6 (hexagonal network).
The directional graph 901 is in general a planar graph or a graph which can be tiled (extensions are feasible in which this applies only to the sub-graph which does not contain the portal node 902, if the supply lines 904 are not fed in at the edge of the tile arrangement 100).

For the rest of the explanation, it is worthwhile considering not only the portal node 902 but also those nodes 903 which are directly linked to the portal node 902. As described above, these nodes are referred to as input nodes 903, that is to say they represent the reference positions with which the input tile processors in the tile arrangement are associated. The edges from the portal node 902 to the input nodes 903 are referred to in the following text as supply lines 904, and the edges 905 between tile processors are referred to as network links.

Definition 10 (Supply Lines, Network Links, Input Nodes)

Assume that (V, E, g) is a display graph with portal nodes w. The set of supply lines is then defined by
Eₚₒᵣₜ:={e ε E;g⁻(e)=w}
and the set of network links is defined by
Eₙₑₜ:={e ε E;g⁻(e)≠w ˆ g⁺(e)≠w}.

The set of input nodes is defined by
V_{port:=g}⁺ (Eₚₒᵣₜ).

The following text considers the problem situation in which the aim is to transmit an electronic message to each node in a tile arrangement graph from the portal node within one time frame (within one refresh rate).

If this is done, as is obvious from this problem description, on fixed selected routes and routes which have diverged do not cross again, then this means that a directional tree should be chosen as a sub-graph of the tile arrangement graph. This directional graph, which is also referred to as a routing tree, then defines the paths of the information flow uniquely, but not the dynamics of the information flow.

The routing tree is not unique; in general, the set of all possible trees is unimaginably large.

Definition 11 (Permissible Tree Set, Permissible Edge Set)

Assume that (V, E, g) is a display graph with portal nodes w ε V. The set of all permissible directional trees in (V, E, g) is defined as
B:={(V, K, g|_{K}); where K ⊂ E and (V, K, g|_{K}) is a directional tree with the root w}.

The set of all permissible edge sets relating to (V, E, g) is then defined as
κ:={K ⊂ E;(V, K, g|_{K})ε B}.

One example of a permissible tree 1000 is illustrated in FIG. 10, with the corresponding routing paths with the portal node 1001 as the root node in the directional tree 1000.

The following terms are introduced, based on definition 10:

Definition 12 (Supply Lines, Network Links)

Assume that (V, E, g) is a display graph with portal nodes w and that K ε κ. The set of supply lines in K is then defined by
Kₚₒᵣₜ:=Eₚₒᵣₜ∩K.

The set of network links is defined by
Kₙₑₜ:=Eₙₑₜ∩K.

A number of criteria for assessment of trees are listed in the following text:

Definition 13 (Tree Assessments)

Assume that (V, E, g) is a tile graph with portal nodes w ε V and the set κ of permissible edge sets.

$$For all v ∈ V \backslash \{ w \} \\ {l}_{min} ( v ) := {min}_{K ∈ κ} \{ \vert {γ}_{K} ( v ) \vert \} \qquad ( i )$$

defines the distance of the node v from the root w in the display graph.

$$For all K ∈ κ , \\ L ( K ) := {max}_{v ∈ V \backslash \{ w \}} \{ \vert {γ}_{K} ( v ) \vert \} \qquad ( ii )$$

defines the maximum distance in the tree (V, K, g|_{K}) defined by K.

$${L}_{min} := \begin{matrix}min \\ K ∈ κ\end{matrix} \{ L ( k ) \}$$

is then the maximum distance in the tile graph.

$$For all K ∈ κ , \\ D ( K ) := \begin{matrix}max \\ v ∈ V \backslash \{ w \}\end{matrix} \{ {d}_{K} ( v ) \} \qquad ( iii )$$

defines the maximum throughput in the tree (V, K, g|_{K}) which is defined by K.

$${D}_{min} := \begin{matrix}min \\ K ∈ κ\end{matrix} \{ D ( K ) \}$$

is then the maximum throughput in the tile graph.

At least the following problems can be considered in order to select the “best” trees and edge sets:

(i)

The set of trees whose nodes are each at the minimum distance from the root:
O₁:={K ε κ;|γ_{K}(v)|=1ₘᵢₙ(v) for all v ε V\{w}},

(ii)

The set of trees whose maximum separation is a minimum:
O₂:={K ε κ;L(K)=Lₘᵢₙ},

(iii)

The set of trees whose maximum throughput is a minimum:
O₃:={K ε κ;D(K)=Dₘᵢₙ}.

As can easily be seen, O₁⊂O₂.

If O₂∩O₃≠{ }, then all the trees from O₂∩O₃ are particularly suitable for use to minimize the functions L and K and as a routing tree.

If O₂∩O₃≠{ } is not satisfied, then relaxed problem descriptions are required.

(iv)

The set of trees whose maximum separation is at most a ε N₀ greater than the minimum:
O₄^{a}:={K ε k;L(K)≦Lₘᵢₙ+a}

(v)

The set of trees whose maximum throughput is at most b ε N₀ greater than the minimum:
O₅^{b}:={K ε k;D(K)≦Dₘᵢₙ+b}.

For a suitable choice of a, b ε N₀, then O₄^{a}∩O₅^{b}≠{ } is almost possible.

However, the problem can also be described as a multicriteria combinational optimization problem with two target functions.

The routing tree 1000 illustrated in FIG. 10 is undoubtedly not optimum for the tile graph illustrated in FIG. 9b, to be precise not on the basis of any of the above criteria. The tree 1100 illustrated in FIG. 11 is, in contrast, cut by 0₃, even in O₁.

The above text has explained how the information flow paths in the tile network can be defined by the selection of a routing tree from a permissible tree set. In order to supply the display unit nodes with the information that is required to construct the image, an electronic message is transmitted along these paths to each node from the portal node. In general, it is not possible to transmit all of the electronic messages in parallel since specific capacity levels, governing how many messages can be transmitted in one clock cycle via one edge and how many messages can be temporarily stored in one node (queue), must not be exceeded. A time sequence (dynamics) for the information flow should thus be defined.

In the following text, (V, E, g) is assumed to be a tile graph with portal nodes w. It is assumed that r:=|V|−1 and V={v₀,v₁, . . . vᵣ}, v₀=w.

If K ε κ is also assumed, then certain “overall” routing matrices τ and then certain “individual” routing matrices σ¹, 1=1, . . . , r are introduced.

τ will contain the information as to how many electronic messages can be transmitted via the individual edges from K in the individual clock cycles. In this case, conditions are formulated for τ such that the capacities are complied with and an electronic message is finally present in each node. No distinction in τ is yet drawn between different messages (that is to say the individual tile data items). It is not immediately evident at this stage from τ how routing takes place or can take place for a specific individual tile data item to the respective intended tiles. However, τ allows certain “individual” routing matrices σ¹, 1=1, . . . , r to be derived with describe precisely this routing of the individual tile data items to the intended tiles v₁, 1=1, . . . r. The “individual” routing matrices σ¹, 1=1, . . . , r are in this case not necessarily unique, but the assessment of the routing on the basis of the routing duration will essentially depend only on τ. For the purposes of the following text, a routing is thus considered as being given just by τ.

Definition 14 (Routing Map, Routing Matrix)

Assume that K={k_{1, . . . ,}kᵣ} ε κ (consider: |K|=|V|−1). Assume that cₚₒᵣₜ, cₙₑₜ, q ε N. A (cₚₒᵣₜ, cₙₑₜ, q)-routing map or matrix over the tree (V, K, g|_{K}) defined by K is a matrix

$$τ = ( {τ}_{ij} ) {i = 1 , … , n}_{j = 1 , … , r} ∈ {N}_{0}^{n , r} , n ∈ N ,$$

having the following characteristics:

(i)

τᵢⱼ≦cₚₒᵣₜ for all j ε {1, . . . , r} where kⱼ ε kₚₒᵣₜ and all i ε {1, . . . , n}, as well as τᵢⱼ≦cₙₑₜ for all j ε {1, . . . , r} where kj ε Kₙₑₜ and all i ε {1, . . . , n},

$$\begin{matrix}for all v ∈ V \backslash \{ w \} and 1 \leq m \leq n then \\ {\sum }_{1 \leq i \leq m - 1} {{\sum }_{1 \leq j \leq r ,}}_{{k}_{j} ∈ {K}_{term} ( v )} {τ}_{ij} - {\sum }_{1 \leq i \leq m} {{\sum }_{1 \leq j \leq r ,}}_{{k}_{j} ∈ {K}_{init ( v )}} {τ}_{ij} \geq 0 , & ( ii ) \\ for all v ∈ V \backslash \{ w \} and 1 \leq m \leq n then \\ {\sum }_{1 \leq i \leq m} {{\sum }_{1 \leq j \leq r ,}}_{{k}_{j} ∈ {K}_{term ( v )}} {τ}_{ij} - {\sum }_{1 \leq i \leq m} {{\sum }_{1 \leq j \leq r ,}}_{{k}_{j} ∈ {K}_{init ( v )}} {τ}_{ij} \leq q , & ( iii ) \\ for all v ∈ V \backslash \{ w \} then \\ {\sum }_{1 \leq i \leq n} {{\sum }_{1 \leq j \leq r ,}}_{{k}_{j} ∈ {K}_{term ( v )}} {τ}_{ij} - {\sum }_{1 \leq i \leq n} {{\sum }_{1 \leq j \leq r ,}}_{{k}_{j} ∈ {K}_{init ( v )}} {τ}_{ij} = 1. & ( iv )\end{matrix}$$

cₚₒᵣₜ is called the capacity of the supply lines, cₙₑₜ is called the capacity of the network links, and q is called the maximum queue length.
|τ|:=n
is called the routing duration. The set of all (cₚₒᵣₜ, cₙₑₜ, q) routing matrices over (V, K, g|_{K}) is referred to as: [symbol] cₚₒᵣₜ,cₙₑₜ,q^{(K)}.

The extension with respect to the already considered routing trees primarily includes τ additionally containing a time component.

The matrix entry τᵢⱼ, i ε {1, . . . n} j ε {1, . . . r} states that τᵢⱼ messages will be transmitted via the edge kⱼ in the i-th clock cycle.

The condition (i) guarantees compliance with predetermined supply line capacities and network capacities.

The condition (ii) ensures the necessary causality in the network. Messages can be passed on from one node only if they have already been transmitted (that is to say at least one clock cycle previously) to this node.

The condition (iii) takes account of storage space restrictions in the node.

Finally, on the basis of condition (iv), there is one and only one message in the node after n time units.

Thus, together with the routing tree, the routing matrix indicates a routing method with details of the timing of the individual steps, which supplies the network with messages at the same time.

The following items are defined:

Definition 15 (Routing)

Assume that cₚₒᵣₜ, cₙₑₜ, q ε N. A (cₚₒᵣₜ, cₙₑₜ, q)-routing is a tuple (K, τ) consisting of a permissible edge length K={k_{1, . . . ,}kᵣ}ε κ and a routing matrix τ ε R_{c}_{ₚₒᵣₜ}_{,c}_{ₙₑₜ}_{,q}(K). The set of all routings is referred to as R_{c}_{ₚₒᵣₜ}_{,c}_{ₙₑₜ}_{,q}.

The following text now describes how the dynamic routing is achieved for each individual node.

For this purpose, matrices σ¹ε {0,1}^{n,r}, 1=1, . . . , r, are defined on the basis of the following algorithm:

τ⁰ := τ;
for 1 = 1, . . . , r:
{

σ¹ := 0^{n,r} ∈ {0,1}^{n,r};
assume that (kₚ_{₁} , . . . , kₚ_{_{z}}), z ∈ N, the path from w to v₁;
i_{z+1} := n + 1;
for y := z, . . . , 1 in descending order:
}

${i}_{y} := max \{ i ∈ \{ 1 , … , {i}_{y + 1} - 1 \} : {τ}_{i , {p}_{y}}^{l - 1} > 0 \} ;$

${σ}_{{i}_{y} {p}_{y}}^{l} := 1 ;$

}
σ¹ := τ^{l-1} − σ¹;

}

It can easily be shown that the algorithm is well-defined, and that τ^{r}=0^{n,r}. In consequence:

$${\sum }_{1 \leq 1 \leq r} σ l = τ . \\ and$$

$${\sum }_{1 \leq i \leq n} {{\sum }_{1 \leq j \leq r ,}}_{{k}_{j} ∈ {K}_{term ( {v}_{\tilde{1}} )}} {σ}_{ij}^{l} - {\sum }_{1 \leq i \leq n} {{\sum }_{1 \leq j \leq r ,}}_{{k}_{j} ∈ {K}_{init ( {v}_{\tilde{1}} )}} {σ}_{ij}^{l} = {δ}_{1 \tilde{1}} .$$

for all 1, \tilde{1} ε {1, . . . ,r}. A matrix entry σᵢⱼ¹=1 states that the message at v₁ is passed on via the edge kⱼ in the i-th clock cycle.

Two lemmata are listed as an evidential step relating to the above well-defined nature of the algorithm:

Lemma 16 (Well-Defined Nature of σ¹)

Assume that 1 ε {1, . . . , r}. If τ¹⁻¹ ε N₀^{n,r} satisfies the condition (ii) from definition 14 for all v ε V\{w} and the condition (iv) from definition 14 for v:=e₁, then σ¹ can be selected using the algorithm.

Lemma 17 (Characteristics of τ¹)

Assume that 1 ε {1, . . . , r}. If τ¹⁻¹ ε N₀^{n,r} satisfies the preconditions of lemma 16 and σ¹ is selected using the above algorithm, then τ¹ also satisfies the preconditions of lemma 16.

Definition 18 (Routing Matrix to an Individual Node)

Assume that cₚₒᵣₜ, cₙₑₜ, q ε N. Assume that (K, τ) ε R_{c}_{ₚₒᵣₜ}_{,c}_{ₙₑₜ}_{,q} and assume that the matrices σ¹, 1=1, . . . , r, are chosen using the above algorithm. The σ¹, 1=1, . . . , r, are then called routing matrices to the nodes v₁, 1=1, . . . , r with regard to (K,τ).

The opposite procedure is often adopted for the construction of the matrices τ and σ¹, 1=1, . . . , r. Matrices σ¹, 1=1, . . . , r, are defined by stating the time sequence in which the message is passed on to v₁ via the path γ_{K}(v₁). τ is then given by

$$τ \text{:} = {\sum }_{1 \leq 1 \leq r} {σ}^{1} .$$

The time sequence of the routing to each individual node and thus the σ¹, 1=1, . . . , r, are in this case chosen such that the capacities of edges and nodes are not exceeded, that is to say τ satisfies the points (i) and (iii) from definition 14.

Criteria for “advantageous” and, if possible, “optimum” selection of routing methods in a display unit graph are stated in the following text. In the following text, a routing is referred to as being optimum when it takes the shortest possible time. In order to allow this to be defined in mathematical terms, the following expressions are introduced.

In this case, assume that (V, E, g) is always a display unit graph, and, as before, V={v₀, . . . Vᵣ} where v₀=w.

Definition 19 (Minimum Routing Duration)

(i)

Assume that K={k₁, . . . . kᵣ} ε κ and that cₚₒᵣₜ, cₙₑₜ, q ε N. Then

$${T}_{{c}_{port} , {c}_{net} , q}^{min} ( K ) \text{:} = τ ∈ {R}_{{c}_{port} , {c}_{net , q}}^{min} ( K ) \{ \vert τ \vert \}$$

defines the minimum routing duration via the tree (V,K,g_{K}). which is defined by K.

(ii)

Assume that cₚₒᵣₜ, cₙₑₜ, q ε N. Then

$${T}_{{c}_{port} , {c}_{net} , q}^{min} \text{:} = {min}_{K ∈ κ} \{ {T}_{{c}_{port} , {c}_{net} , q} ( K ) \}$$

defines the minimum routing duration in the tile graph.
Definition 20 (Optimum Routing)

(i)

Assume that K={k₁, . . . kᵣ} ε κ and that cₚₒᵣₜ, cₙₑₜ, q ε N. The expression an optimum routing matrix in the tree (V,K,g|_{K}) defined by K is understood to mean a routing matrix from the following set:

$${R}_{{c}_{port} , {c}_{net} , q}^{min} ( K ) \text{:} = \{ τ ∈ {R}_{{c}_{port} , {c}_{net} , q} ( K ) ; \vert τ \vert = {T}_{{c}_{port ,} {c}_{net} , q}^{min} ( K ) \}$$

(ii)

Assume that cₚₒᵣₜ, cₙₑₜ, q ε N. The expression optimum routing is understood to mean routing from the following set:

$${R}_{{c}_{port} , {c}_{net} , q}^{min} \text{:} = \{ \begin{matrix} ( K , τ ) ; K = \{ {k}_{1} , … , {k}_{r} \} ∈ κ , τ ∈ {R}_{{c}_{port} , {c}_{net} , q} ( K ) \\ and \vert τ \vert = {T}_{{c}_{port} , {c}_{net} , q}^{min}\end{matrix} \}$$

The choice of an optimum routing matrix when the routing tree has already been defined is simple in the sense of definition 20 (i). This has been explained in the previous section for special cases of cₚₒᵣₜ and cₙₑₜ=1 and cₚₒᵣₜ and cₙₑₜ>1.

The solution to the optimization problem posed in definition 20 (ii) with free choice of the routing tree is considerably more difficult. The problem is generally too complex to be solved exactly. For this reason, the following text explains heuristic methods to solve it. The solution to the optimization problem from definition 20 (i) with a defined routing tree in this case provides important strategies for suitable choice of the routing tree.

First of all, the special case will be explained for which cₚₒᵣₜ=cₙₑₜ=1.

Assume that q ε N, undefined and that K ε κ. Then, without any restriction to generality, Kₚₒᵣₜ=Eₚₒᵣₜ (otherwise consider u ε Vₚₒᵣₜ\g⁺(Kₚₒᵣₜ) not as an input node, that is to say set Vₚₒᵣₜ:=g⁺(Kₚₒᵣₜ)).

Since cₚₒᵣₜ=1, it can easily be seen that:

$${T}_{{c}_{port ,} {c}_{net} , q}^{min} ( K ) \geq {max}_{v ∈ {V}_{Port}} {d}_{K} ( v ) = D ( K ) .$$

Equality therefore exists. In this context, assume that:

$$n \text{:} = {max}_{v ∈ {V}_{Port}} {d}_{K} ( v ) = D ( K ) .$$

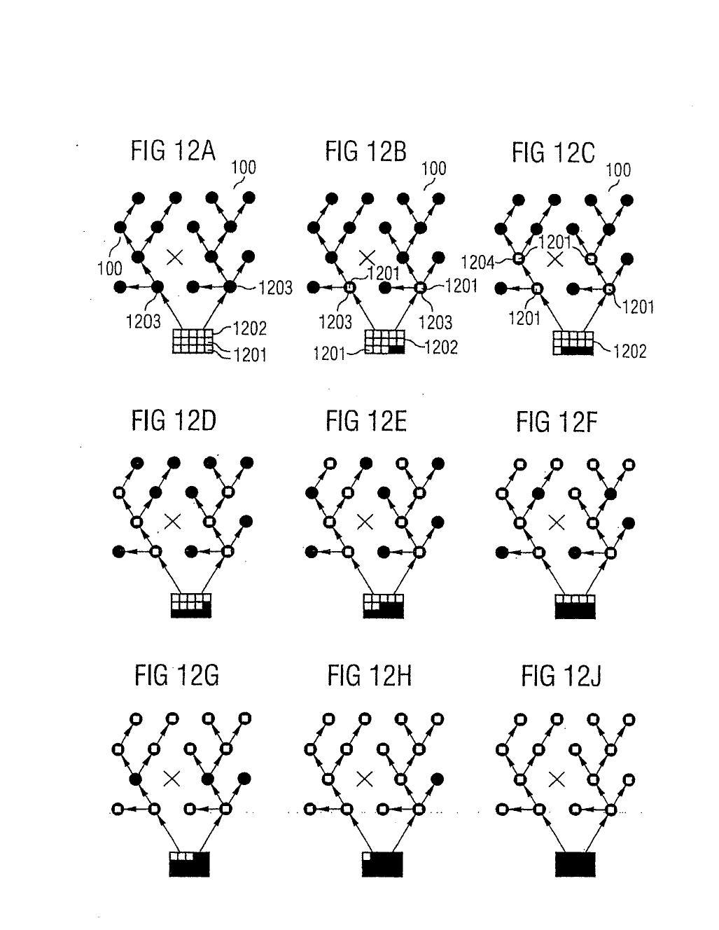

The idea of the following routing is that one electronic message arrives at the input node via each supply line in each clock cycle and is passed on step by step in the subsequent time intervals to their respective destination nodes, that is to say to the destination tile processor. Messages to the nodes which are furthest away are fed in first of all, followed by messages to the nodes which are close to the portal node, that is to say tile processor. One corresponding routing is illustrated in FIG. 12a to FIG. 12i for the case where cₚₒᵣₜ=cₙₑₜ=1. The small quadrilaterals each symbolize one electronic message 1201, which is passed via the portal node 1202 for the input tile processors 1203 into the tile arrangement 100.

The situation where U ε Vₚₒᵣₜ is considered, and the following relationship is set:
d:=d_{K}(u)=|V_{K}(u)|. It is assumed that
V_{K}(u)={v_{q}_{₁}, . . . v_{q}_{_{d}}} where v_{q}_{₁}=u is arranged such that
Γ_{K}(v_{q}_{ᵢ},v_{q}_{ⱼ})={ } (1)
for i>j. This assumption is true in particular when:
|v_{K}(v_{q}_{ᵢ})|≧|v_{K}(v_{q}_{ⱼ})|
for i>j. It is now assumed that 1 ε {1, . . . , d}, undefined, and that (kₚ_{₁}, . . . , kₚ_{_{z}}), z ε N, the path from w to v_{q}_{₁}. Then, for all i ε {1, . . . , n} and j ε {1, . . . r}, set

$${σ}_{ij}^{ql} := \{ \begin{matrix}1 & if 1 + ( d - 1 ) \leq i \leq z + ( d - 1 ) and {p}_{i - ( d - 1 )} - j , \\ 0 & else\end{matrix} \}$$

In order to show that σ^{q1} defines a routing matrix for v_{q1}, it is sufficient to show that:
z+(d−1)≦n,
because the n clock cycles are then sufficient to pass the message to its destination v_{q1} on the basis of our construction of σ^{q1}. On the basis of (1), 1≧z, and thus
z+(d−1)≦d≦n
and this is therefore demonstrated.

On the basis of the above considerations, the σ¹ for all 1 ε {1, . . . , r} can finally be determined by analysis of all the input nodes. The expression:

$$τ \text{:} = {\sum }_{l = 1}^{r} {σ}^{1} .$$

is formed as normal. As can easily be seen, τ then actually defines a (1,1,q)-routing via (V,K,g|K) for undefined q ε N and, on the basis of the above considerations, is optimum. Thus:

$${T}_{{c}_{port} , {c}_{net} , q}^{min} ( K ) = {max}_{v ∈ {V}_{port}} {d}_{K} ( v ) = D ( K ) .$$

FIG. 12a illustrates the initial state, in which all the messages 1201 are stored in the portal node 1202. After a first clock cycle, the first two messages 1201 are passed to the input tile processors 1203, that is to say to the tile processors in the tile arrangement 100; via which the information can be supplied via the tile arrangement to the respective tile processors, where they are temporarily stored (see FIG. 12b). After a further time step (see FIG. 12c), the first two messages have already been transmitted to first inner nodes 1204 in the tile arrangement, and two further messages 1201 have been passed to the input tile processors 1203. After a further time step in each case, the respective electronic message 1201 has always been passed on by one tile processor in each case, and two new messages 1201 have in each case been passed into the tile arrangement 100, that is to say in other words they have been supplied to the input tile processors 1203. FIG. 12d, FIG. 12e, FIG. 12f, FIG. 12g, FIG. 12h and FIG. 12i illustrate the successive progress of the transfer of the messages as far as their respective destination tile processor, after one clock cycle in each case.

The following approach can be adopted as one possible strategy for the choice of an optimum routing for free choice of the routing tree in the sense of definition 20 (ii):

Choose the routing tree such that all the input nodes as far as possible have the same throughput (to be more precise: that they differ by a maximum value of 1) and set the routing matrix in accordance with the above considerations.

The second special case will be explained briefly in the following text, for which:
c:=cₚₒᵣₜ=cₙₑₜ>1, q≧c.

Assume that K ε κ. Without any restriction to generality, once again:
Kₚₒᵣₜ=Eₚₒᵣₜ.

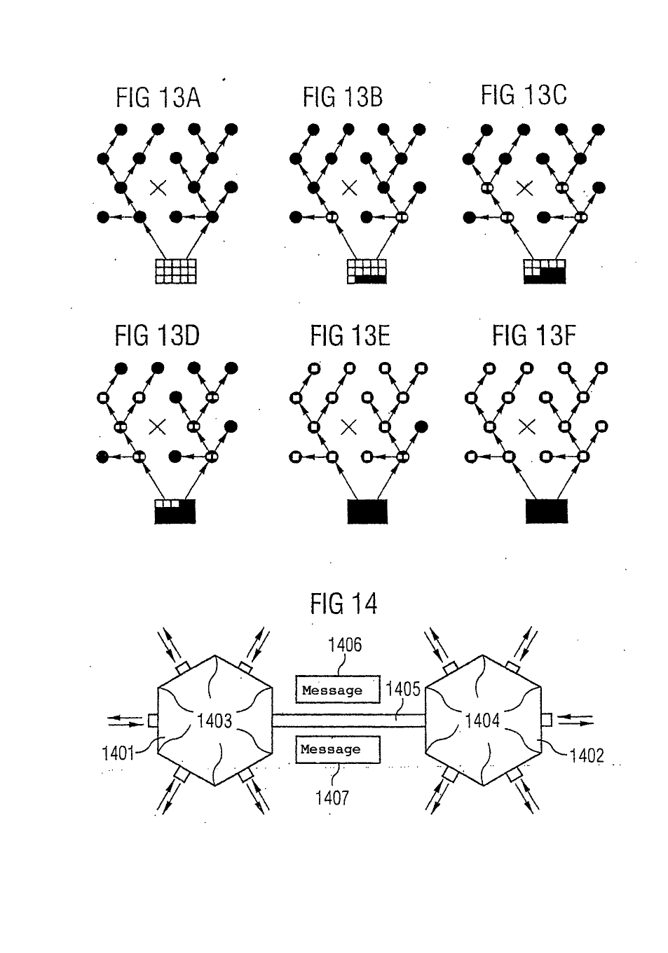

In this situation, it is more difficult to define the minimum routing duration in advance. A routing matrix is thus developed which defines an optimum (cₚₒᵣₜ, cₙₑₜ, q)-routing via (V, K, g|K). Finally, this allows the minimum routing duration to be determined. The idea for this routing variant is equivalent to that developed already for the case where cₚₒᵣₜ=cₙₑₜ=1 with the exception that, in this case c=cₚₒᵣₜ=cₙₑₜ messages are always entered in an input node at the same time in order to be passed on from there to the nodes which are furthest away and have not yet been notified. One such routing is once again sketched in FIG. 13a to FIG. 13f.

First of all, assume that:

$$\tilde{n} \text{:} = {max}_{v ∈ {V}_{port}} {d}_{K} ( v ) .$$

Then assume that u ε Vₚₒᵣₜ and that d:=d_{K}(u)=|V_{K}(u)|. It is assumed that (V_{K}(u)=(v_{q1}, . . . , v_{qd}) is arranged with v_{q1}=u such that
|γ_{K}(v_{qi})|≧|γ_{K}(v_{qi})|
if i>j. Assume that 1 ε{1, . . . , d} and

$$\hat{d} \text{:} = [ \frac{d - 1}{c} ] ,$$

that is to say the next smaller integer to

$$\frac{d - 1}{c} .$$

Assume that (kₚ₁, . . . , k_{pz}) is the path from w to v_{q1}. Then, for all iε{1, . . . , ñ} and j ε {1, . . . , r}, set:

$${\tilde{σ}}_{ij}^{q 1} \text{:} = \{ \begin{matrix}1 & if & 1 + \hat{d} \leq i \leq z + \hat{d} and {p}_{i - \hat{d}} = j \\ 0 & else & \end{matrix} \} .$$

As before, in this way determine \tilde{σ}¹ for all 1 ε {1, . . . , r} and set:

$$\tilde{τ} \text{:} = {\sum }_{l = 1}^{r} {\tilde{σ}}^{1} .$$

Now delete all those rows in \tilde{Ε} which are equal to 0, that is to say set:

$$n \text{:} = min \{ \hat{n} ∈ N ; {τ}_{ij} = 0 for all \hat{n} < i \leq \tilde{n} and j = 1 , … , r \}$$

$$and$$

$$τ \text{:} = ( {\tilde{τ}}_{ij} )$$

$$i = 1 , … , n . \\ j = 1 , … , r$$

It can be shown that τ is an optimum (cₚₒᵣₜ, cₙₑₜ, q)-routing via (V,K,g|K) for any q≧c. Furthermore:

$$⌈ \frac{D ( K )}{c} ⌉ = {max}_{v ∈ {V}_{port}} ⌈ \frac{{d}_{K} ( v )}{c} ⌉ \leq n \leq {max}_{v ∈ {V}_{port}} {d}_{K} ( v ) = D ( K )$$

$$and$$

$$L ( K ) \leq n .$$

The actual magnitude of n now depends on the specific structure of the branches of the input nodes, but can easily be calculated. First of all, for each u ε Vₚₒᵣₜ, the number of clock cycles nᵤ are calculated which are required in order to route all of the messages to the nodes in the branch from u. V_{K}(u) and d are in this case assumed as above. Then:

$${n}_{u} \approx {max}_{1 ∈ \{ 1 , … , d \}} ( \vert {γ}_{K} ( {v}_{q 1} ) \vert + ⌊ \frac{d - 1}{c} ⌋ ) .$$

The routing duration n is obtained from this as:

$$n = {max}_{u ∈ {V}_{port}} {n}_{u} .$$

As an alternative strategy for the choice of an optimum routing with free choice of the routing tree in the sense of definition 20 (ii), the following approach can be adopted:

Choose the routing tree such that all the input nodes as far as possible have the same throughput and that the tree has “sufficiently wide branches” in the branches of the input nodes, such that n approaches as close to

$$[ \frac{D ( K )}{c} ]$$

as possible. Set the routing matrix in accordance with the above considerations.

“Sufficiently wide branching” clearly exists when the following statement applies to all the input nodes: consider the branch of the input node, organize the associated nodes on the basis of increasing path length. The path lengths of the nodes should then increase only all the c nodes by the value 1, that is to say c nodes of the path length 2, c nodes of the path length 3, . . . .

If the capacities of the respective nodes and supply lines are low, it is more important to ensure that the throughput in the input node is uniform since, in this situation, the throughput through the input node is normally the critical factor for limiting the minimum routing duration. In this situation, the input nodes to a certain extent represent a constriction in the tree. If the capacities are higher, it is in contrast more important to ensure a sufficiently large number of branches in the tree, and thus short path lengths.

In this situation, it is normally the path lengths which limit the minimum routing duration. Very high capacities are in contrast no longer worthwhile at all since the hexagonal network limits the number of branches, and certain minimum path lengths are governed by the topology of the network, that is to say the topology of the networking or coupling of the tile processors in the tile arrangement 100.

Exemplary embodiments of the methods for self-organization of the tile processors in the tile arrangement will be explained in the following text.

The following situation is assumed on the basis of the exemplary embodiments:
the central external unit, that is to say the portal processor, does not know the topology of the network, that is to say it does not know the arrangement of the tile processors in the processor arrangement.
The tile processors are networked with one another by bidirectional links.
Direct communication takes place only between respectively mutually directly adjacent neighboring tile processors.
Communication is based on interchanging electronic messages, as illustrated by way of example in FIG. 14.
Each contact with other components for self-organization (position finding, creation of routing tables etc.) and for image construction is handled by different messages. FIG. 14 illustrates a tile processor of a first tile 1401 with a hexagonal shape, as well as a tile processor of a second tile 1402, which likewise has a hexagonal shape. The first tile 1401 has six bidirectional communication interfaces 1403, as is in each case indicated by a double-headed arrow in FIG. 14. The second tile 1402 also has six bidirectional communication interfaces 1404. The first tile 1401 and the second tile 1402 are coupled to one another via a supply line 1405, that is to say an electrically conductive link which may, of course, also be in the form of an optical communication link, or as a radio link, such that on the one hand a first message 1406 can be transmitted from the first tile 1401 to the second tile 1402, and such that on the other hand a second message 1407 can be transmitted from the second tile 1402 to the first tile 1401.

On the basis of the present exemplary embodiments, when no faults are present, all of the tiles 1401, 1402 and thus all of the tile processors are completely networked with one another via the corresponding supply lines and the bidirectional communication interfaces.

The problem mentioned above is solved by self-organization based on local message interchange between two mutually directly adjacent tiles 1401, 1402.

The self-organization method thus includes distributed uniform algorithms which transmit these electronic messages via their communication interfaces.

During the course of the method, the tile processor units learn the alignment of their tiles and their two-dimensional position within the tile arrangement, as well as the distance between the respective tile and the portal processor, in general a reference position. The reference position may also be the position of a processor unit which is located at the input point of the tile arrangement 100. In further steps, routing paths are produced locally between the individual tiles and the portal processor. The algorithms for choice of the routing paths are in this case designed such that the routing duration is minimized as far as possible for a uniform information flow. The self-organization process also defines the algorithm for distribution of the information when the tile arrangement 100 is used for presenting information by means of the tile arrangement 100. Owing to the special configuration of the method, the shape of the tile arrangement 100 and thus individual components that have failed are irrelevant, thus achieving a high degree of fault tolerance according to the invention.

The overall method includes a combination of the following method elements:
uniform algorithm elements for message processing, which are carried out by the tile processors,
a control algorithm for the portal processor,
a message catalogue which represents the interface for the algorithm elements.

The following text is based on the assumption of the tiles being networked hexagonally within the tile arrangement 100, without any restriction to generality.

However, according to one embodiment of the invention, the transfer of the algorithms to the orthogonal situation or other two-dimensional networks is completely analogous to this description that is provided in the following text.

On the basis of a communication layer model, functions which are located underneath the functions required according to the invention, for example ping messages, the protection of the transmission by means of checksums, reception confirmation, requesting defective messages again, etc. will not be considered in the following text. However, they can be implemented without any problems in the scope of the invention.

In general, it can be stated for the method steps that are described in the following text that each tile processors maintains a data record on the basis of received messages for each of its adjacent tile processors, with this data record storing the information obtained in a memory that is associated with the respective processor.

In a first method element, the tile processors learn a uniform alignment of the tiles.

Since all of the links of the portal processor on the basis of the above convention are linked to the south-west side of the corresponding input tile processors and the input points, this can be used to produce coherence.

Measurement coherence messages which contain, as a parameter, the number of links by which the reception link is away from the easterly direction, as defined above, in the counter clockwise direction, are sent for this purpose.

Each tile processor is set to be incoherent, for initialization.

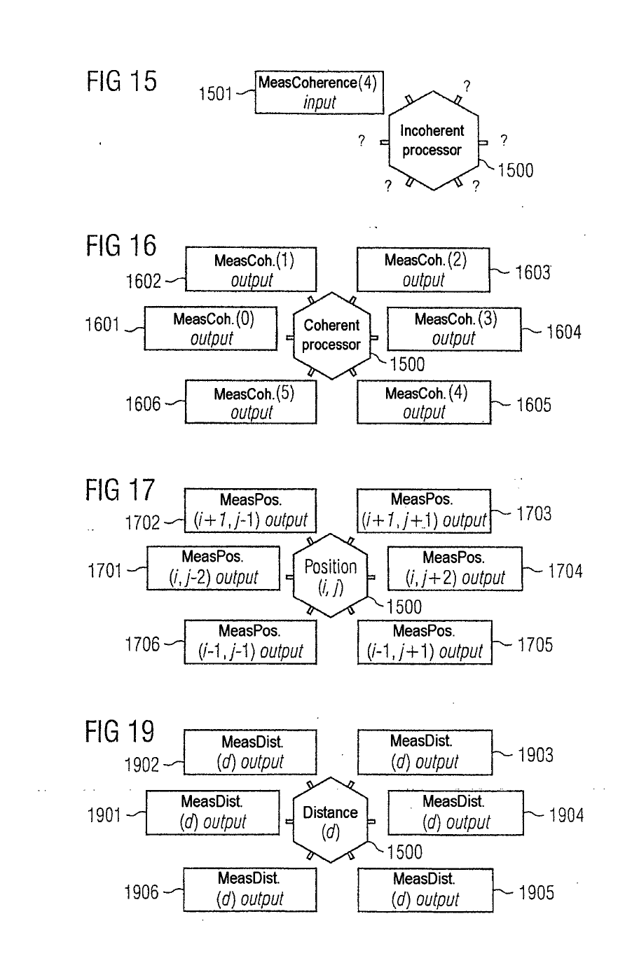

On receiving a measuring coherence message 1501 (see FIG. 15), the processor unit 1500 which has received the measurement coherence message 1501 carries out the following steps:
1. If the processor unit 1500 is already coherent, the processing is ended.
2. The easterly direction is determined on the basis of the message parameter, and all of the link designations/link numbers are appropriately aligned.
3. The processor unit 1500 is set to be coherent.
4. Measurement coherence messages 1601, 1602, 1603, 1604, 1605, 1606 are sent via all the links by the processor unit 1500 whose parameters have in each case been set such that the processor units 101 which have received the respective measurement coherence message 1601, 1602, 1603, 1604, 1605, 1606 can align themselves correctly in the above manner (see FIG. 16).

The method element for uniform alignment is started by the portal processor transmitting the measurement coherence message (2) with the parameter value 2 via its links to the respective input tile processors. The method element is terminated when the last processor unit has become coherent.

The number of clock cycles required to carry out the process corresponds to the maximum distance of a tile processor from the portal processor. It may possibly require one or two further clock cycles before the last message communication “dies”.

In a further method element, the tile processors interchange electronic messages with one another in order to automatically determine their physical position within the tile arrangement.

Since the hexagonal array of the tiles within the tile arrangement 100 in each includes offset rows, the coordinate system for this exemplary embodiment is chosen such that the column numbers in the rows alternately have even numbers or odd numbers.

In this context, it should be noted that the coordinate system for a tile arrangement with an orthogonal structure can be chosen canonically, very easily.

In the case of a hexagonal array, it is possible in the manner described above for a processor to determine the positions of its adjacent tiles independently of the geometry of the tile arrangement from its own position (i, j), where the row is i and the column is j.

The respective positions for the processor unit of a tile 1500 are illustrated in FIG. 17. As can be seen from FIG. 17, there is an agreed convention that the column numbers rise from west to east (from left to right), and the row numbers rise from south to north (from bottom to top).

For position-finding on the basis of this exemplary embodiment, measurement position messages 1701, 1702, 1703, 1704, 1705, 1706 are interchanged, which contain two parameters, specifically the row number and the column number, which the processor unit that is sending the measurement position message 1701, 1702, 1703, 1704, 1705, 1706 has calculated as the position assumed by it of the processor unit which is receiving the respective message 1701, 1702, 1703, 1704, 1705, 1706.

For initialization purposes, the position of each tile processor is defined to be (0,0). The process of position-finding starts in each tile processor as soon as it has become coherent, as has been explained above.

The measurement position messages 1701, 1702, 1703, 1704, 1705, 1706 are then sent via all the links, as illustrated in FIG. 17.

On receiving a measurement position message 1701, 1702, 1703, 1704, 1705, 1706 with the row number z and the column number s, the respective receiving processor unit carries out the following steps:
1. If z>i, where i represents its own line number, then i is set to be equal to z.
2. If s>j, where j represents its own column number, then j is set to be equal to s.
3. If step 1 or step 2 has resulted in the change in its own position (i, j), then measurement position messages 1701, 1702, 1703, 1704, 1705, 1706 are sent via all the links, as illustrated in FIG. 17.

The method element is ended when no more position changes occur.

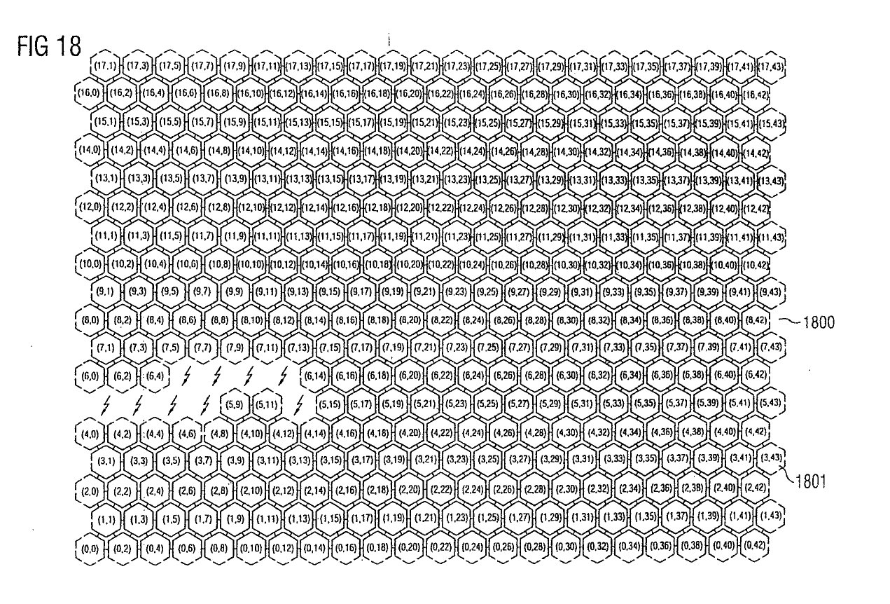

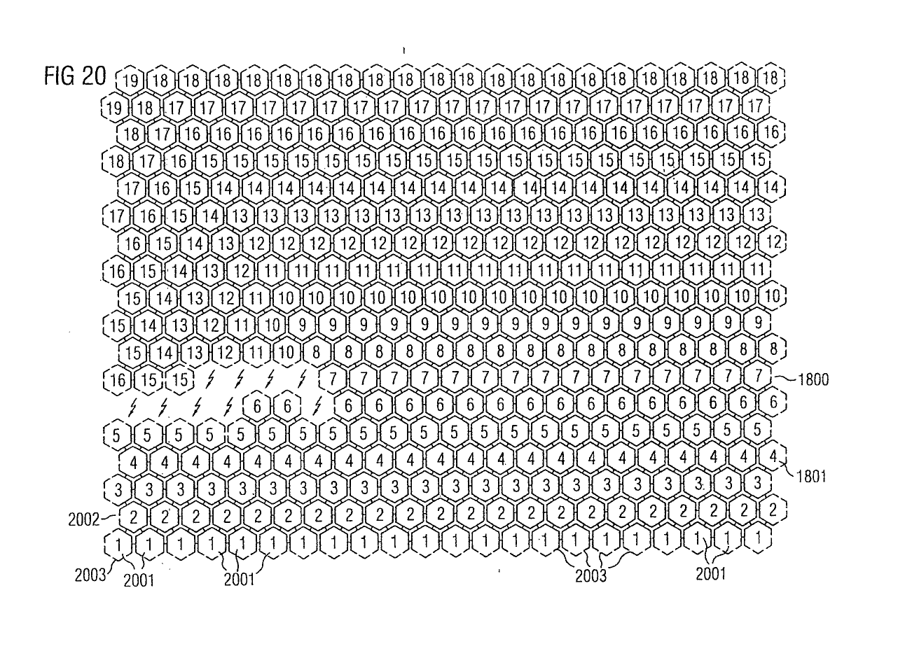

FIG. 18 illustrates an example of the tile arrangement 1800 with various defects, which has determined the positions of the individual processors, and thus of the tiles, automatically using the procedure described above. On the basis of this exemplary embodiment, both failed processors, that is to say faulty processors, and failed links have been used. This exemplary embodiment will also be used throughout the rest of the course of this description in two variants with a different number of input processor units, in order to describe the other method elements.

The maximum number of clock cycles required to carry out the process is limited by the maximum distance of one tile processor from another tile processor in the processor arrangement. One or two more clock cycles may be required before the last message communication “dies”. Normally, however, the method element can generally be carried out even more quickly, depending on the geometry of the processor arrangement 1800.

In this context, it should be noted that the process of presenting information by the portal processor involves mapping onto the coordinate system of the tile arrangement 1800 determined in this way. During the process of setting up routing paths that is carried out in subsequent method elements, the information which is now stored locally is transmitted to the portal processor, so that appropriate mapping can be carried out in the portal processor.

For each of the tiles 1801, FIG. 18 illustrates its physical position within the tile arrangement 1800, in the form of a value tuple.

In an additional method element, the respective distance of a processor unit and thus of the tile from the portal processor, that is to say the length of the path from the tile processor to the portal processor (see also definition 6) is determined, in general the distance of a tile in the tile arrangement 1800 from a predetermined reference position.

In order to initialize this method element, the distance of each tile 1801 is defined as “infinite”. On the basis of this exemplary embodiment, the distance of each tile processor to the portal processor is defined as a value which is greater than a maximum value which may be assumed as a distance within the tile arrangement.

It is assumed, without any restriction to generality, that the steps of the method element described above have already been carried out.

The distance determination process is then started by the portal processor by sending measurement distance (0) messages to the processor units at the input points to the tile arrangement 1800.

On receiving a measurement distance message with a distance parameter a, the respective processor unit which has received the measurement distance message carries out the following steps:
1. If d≧a+1, where d represents its own distance, then d is set to be equal to a+1.
2. If step 1 has resulted in a change in its own distance d, then measurement distance messages 1901, 1902, 1903, 1904, 1905, 1906 are sent via all the links to the respective adjacent processor units (see FIG. 19). The respective measurement distance message 1901, 1902, 1903, 1904, 1905, 1906 in each case contains, as a parameter, the distance value which the processor unit for the tile 1500 has determined in the previous step.

The method element is terminated when no more distance changes occur.

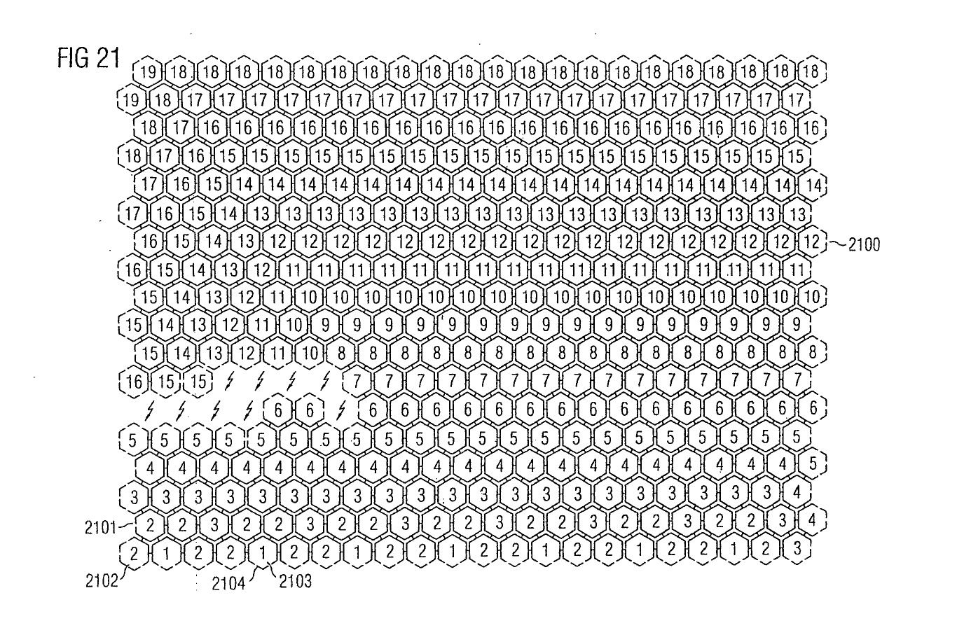

FIG. 20 and FIG. 21 illustrate the tile arrangement 1800 based on a first exemplary embodiment and a tile arrangement 2100 based on a second exemplary embodiment, with all of the processor units 2001 for the tiles in the lowermost row 2002 in the tile arrangement 1800 being coupled to the portal processor via its south-west side 2003 in the tile arrangement 1800 based on the first exemplary embodiment.

In the tile arrangement 2100 based on the second exemplary embodiment, the lowermost row 2101 of the tile arrangement 2100 contains not only tiles 2102 which are not coupled to the portal processor, but also tiles 2101 which are coupled to the portal processor via their communication interfaces 2104 that are arranged on the south-west side. On the basis of the second exemplary embodiment, every third tile in the lowermost row 2101 is connected to the portal processor via its communication interface located on the south-west side.

The number of clock cycles required to carry out this process corresponds to the maximum distance of a tile from the portal processor. Once again, one or two more clock cycles may be required before the last message communication “dies”.

In this context, it should be noted that each processor unit of a tile can also store, on the basis of the respectively received messages, the distance of its direct adjacent processor units from the portal processor locally in itself, for subsequent use.

The processor unit's own distance value is then, as can be seen, changed using an iterative method in this method element if the previously stored distance value is greater than the received distance value, incremented by a predetermined value, in the respectively received message. In the situation where a processor unit changes its own distance value, this produces a measurement distance message and sends this via all the communication interfaces to adjacent processor units, with the measurement distance message in each case containing its own distance as the distance information or the distance value which the received processor unit has from the portal processor, in one case, a value which is increased by a predetermined value from its own distance value, in one case, a distance value which is increased by the value “1”.

The following text describes the method element for regular backward organization.

In order to make it possible to carry out the following method steps, it is necessary for the distance of a tile processor to a respective reference position to have been determined and thus to be known, and in one case, to be stored as respective distance information in the memory of the respective processor.

In the method element which will be described in the following text, the links between the respective processor units will be referred to in the following text as instances, which are denoted as channels.

The sets of the processor units with the portal processor as the root node and the channels as edges between the respective processor units form a tree. This tree is used for the subsequent routing process, as has been described above in conjunction with graph-theory principles.

The channels are determined in the regular manner such that each processor unit is linked by the shortest route to the portal node.

For initialization purposes, each tile processor of a tile 1500 is defined as being “unorganized”. The process of organization is started over all of the links by the portal processor by sending measurement organize messages 2201, 2202, 2203, 2204, 2205, 2206 which have no parameters at all.

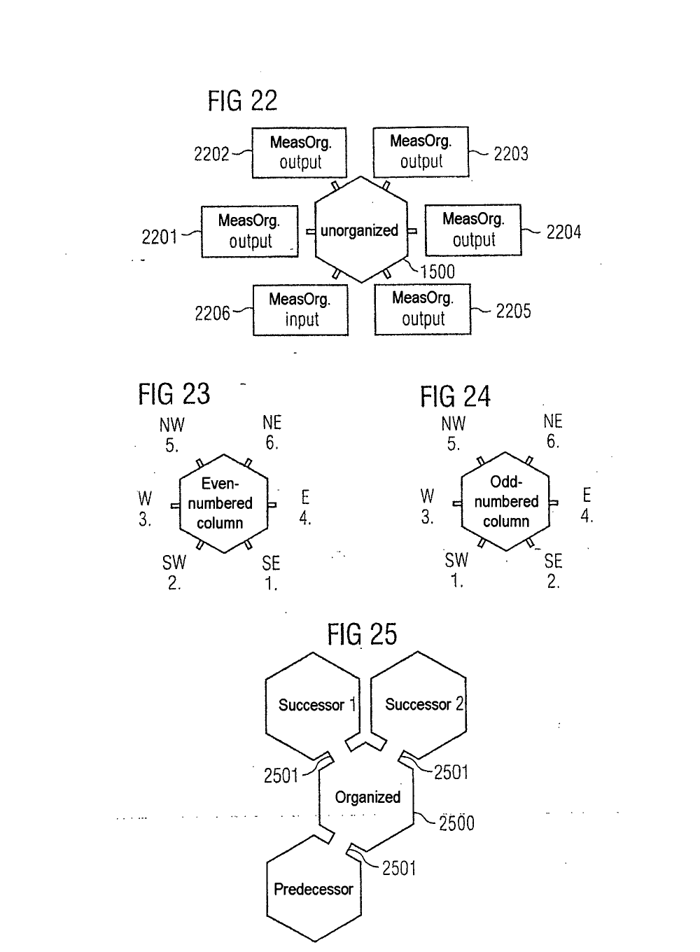

On receiving a measurement organize message 2201, 2202, 2203, 2204, 2205, 2206, the respective processor unit receiving the message carries out the following steps:
1. If the processor unit is already organized, the processing is ended.
2. Additional measurement organize messages are sent via all the links with the exception of the receiving link, that is to say the link via which the measurement organize message 2201, 2202, 2203, 2204, 2205, 2206 has been received (see FIG. 22).
3. On the basis of the already determined distance information, the processor unit determines an adjacent processor unit whose tile is at a shorter distance than it is itself from the reference position, in one case, thus from the portal processor. That adjacent processor unit is selected and defined as the “predecessor” whose tile, as the first in the sequence defined on the basis of FIG. 23 and FIG. 24, has a shorter distance than the tile of the processor unit itself. The link between the processor unit and its “predecessor” is particularly pronounced and is referred to as a “channel”. The set of tile processors with the portal processor as a node and the channels as edges then forms a tree. In the case of a regular display without any errors or faults, this procedure leads to a “zigzag pattern” for definition of the channels.
4. A measurement channel message is sent to the “predecessor”, and the processor unit is set as being organized.

On receiving a measurement channel message, the processor which receives the measurement channel message defines the sender as a “successor”. In a corresponding manner, the link between the processor unit and the “successor” is then a channel.

The method element is terminated once all of the processor units have been organized in this way.

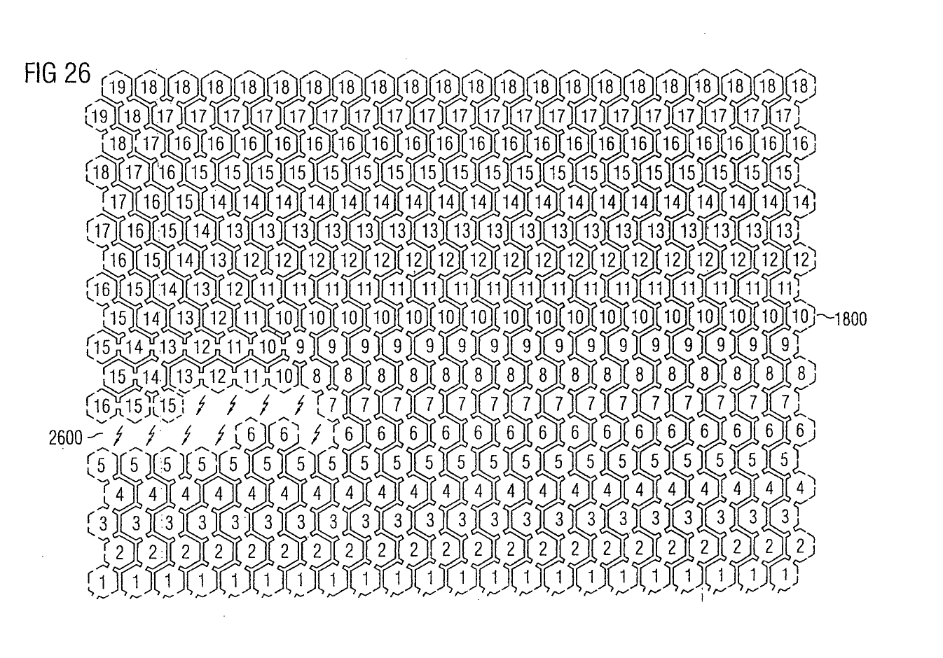

By way of example, FIG. 25 illustrates an organized processor unit for a tile 2500, with the links 2501, which are channels, being visually emphasized. When the display is being used, the information to be displayed or recorded is routed via the channels 2501.

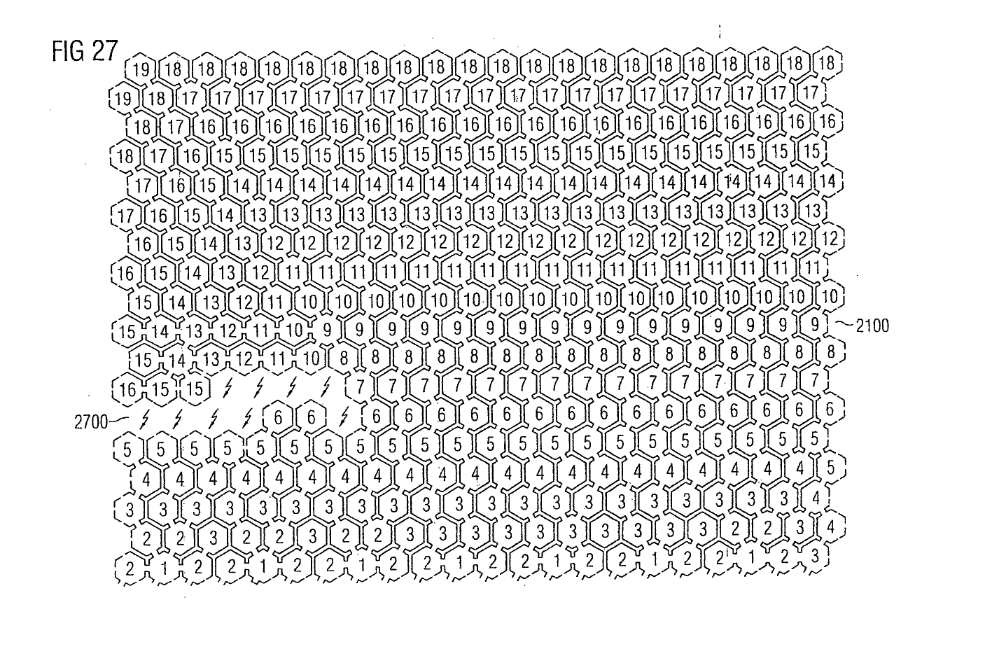

FIG. 26 and FIG. 27 illustrates examples of the tile arrangement 1800 and 2100 once automatic organization process has been carried out, as described above.

The number of clock cycles required to carry out the method element for backward self-organization corresponds to the maximum distance of a tile from the portal processor. In this situation as well, one or two more clock cycles are required before the last message communication “dies”.

The regular backward organization leads to well-balanced trees with sound rectangular tiles.

Since all the tiles within the tile arrangement 1800, 2100 are each connected by the shortest route to the portal, this algorithm determines an element of the “optimum set” O₁, as defined above. In the case of horizontal cracks 2600, 2700, as illustrated in FIG. 26 and FIG. 27, the procedure described above leads, however, to the components of the tile arrangement 1800, 2100 which are shadowed by the crack being supplied essentially by a single supply line from the portal to the display. Additional alternative options for organization will therefore also be described in the following text.

The throughput of a tile processor is of major importance for setting up routing tables.

The throughput is the set of information to be displayed and which must in each case be processed or passed on by this processor.

The mathematical definition of the throughput is stated above, in definition 6.

This number is identical to the set of information which is received via the input channel.

In order to carry out the following method step elements, a tree structure must have been organized in the tile arrangement 1800, 2100, for example by means of channels, as described above.

The method element is started by the portal processor by sending measurement count nodes messages, which have no parameters, via all of the links to the respective input processor units.

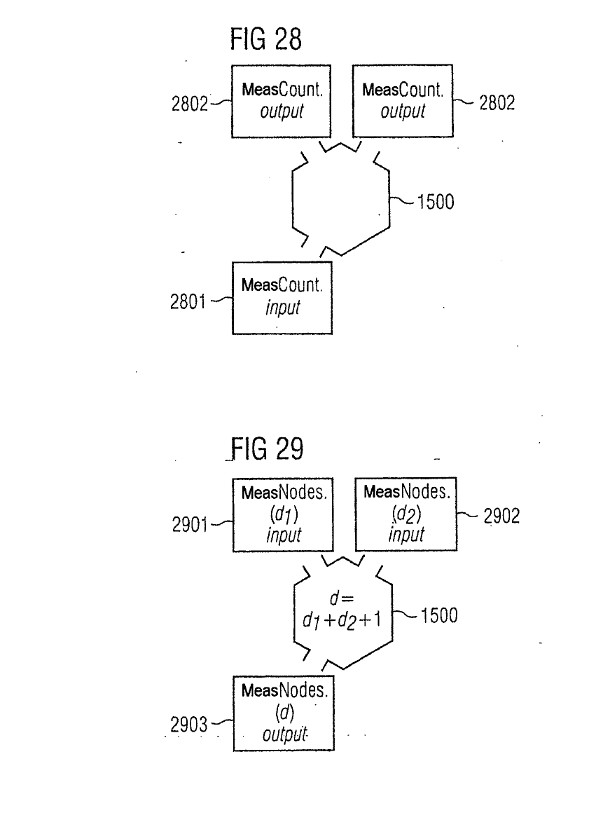

On receiving an arriving measurement count nodes message 2801 via the input channel, the respective processor unit which receives the measurement count nodes message carries out the following steps:
1. Measurement count nodes messages 2802 are in turn sent via all of the output channels of the processor unit which has received the measurement count nodes message, as illustrated in FIG. 28.
2. All of the adjacent processor units which are connected to one another via output channels are marked with a throughput with the throughput value“0”.
3. If no output channels exist, its own throughput is set to the throughput value “1”, and a measurement nodes size message 2901 is sent via the input channel to the respective predecessor processor unit. For one processor unit 1500, FIG. 29 illustrates two incoming measurement nodes size messages, a first incoming measurement nodes size message 2901, which contains the value d₁ and a second incoming measurement nodes size message 2902 with the parameter d₂. On receiving a measurement nodes size message with the throughput parameter \hat{d} via an output channel, the processor unit which receives the measurement nodes size message carries out the following steps:
1. The adjacent processor unit from which the measurement nodes size message 2901, 2902 was received is marked with the throughput parameter of the measurement nodes size message.
2. If at least one output channel is marked with a throughput with the throughput value “0”, the processing is ended.
3. If all of the output channels are marked with a throughput value>0, then its own throughput d is calculated as the sum of all the output throughputs+1.
4. An additional measurement nodes size message 2903 is produced by the processor unit and is sent via the respective input channel with the throughput value d, which is obtained using the following rule, d=d₁+d₂+1 on the basis of the exemplary embodiment described above.

The method element is terminated once the portal processor has received a measurement nodes size message via all of the links.

The number of clock cycles required to carry out the method element corresponds to twice the maximum distance of a tile from the portal processor. In this case as well, one or two more clock cycles may be required before the last message communication “dies”.

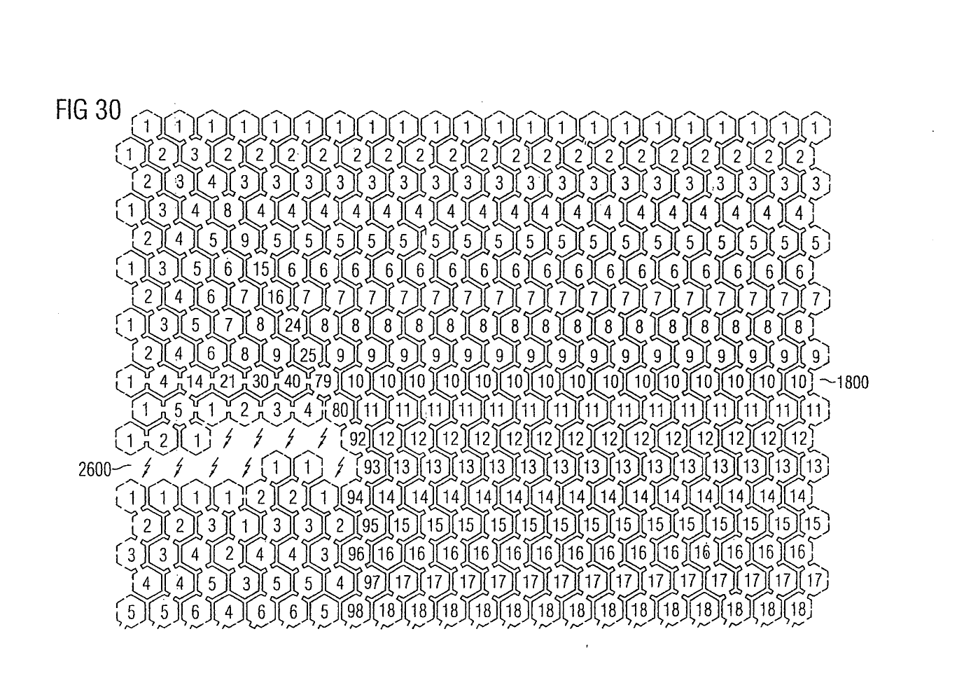

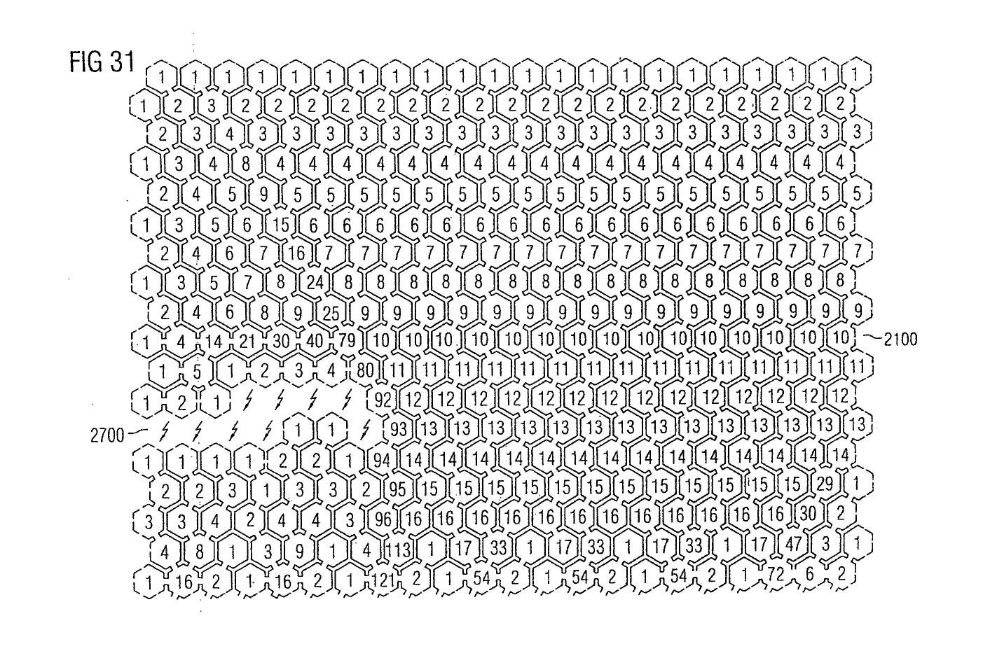

FIG. 30 and FIG. 31 illustrate examples of the tile arrangement 1800 or 2100, respectively, on the basis of which the throughputs have been determined automatically in the manner described above.

The respective throughput value is stated in the respective tile processors. These examples show that the throughputs are very high of those input processor units which have to supply the region of the respective tile arrangement 1800 or 2100 which is shadowed by the respective horizontal crack 2600, 2700.

An alternative organization method is thus described in the following text, which can react even more flexibly to faults or errors, that is to say to defects and irregular shapes of the tile arrangement 1800, 2100.

In order to achieve as uniform a throughput as possible, a heuristic solution approach is used to select a routing tree in the successive sending of so-called measurement token messages which “occupy spaces” in the tile arrangement 1800, 2100.

By analogy with gradual coloring of the tile arrangement 1800, 2100, each input point is sent another “color” with a token, by means of color streams. This results in the tile arrangement 1800, 2100 being subdivided into color regions which are each supplied from the portal node via an input processor unit.

In other words, this means that one “color” or one individual marker is in each case provided for each processor unit that is supplied via a respective. input processor unit.

The expression “color” is used in the following text for illustrative purposes and corresponds to an area marked with the same marking as a “color” region.

The following heuristic strategies are used for distribution:
a token weight determines the maximum extent to which the distance to the portal node may be increased on the basis of the coloring.
Once tiles, that is to say processor units, have been colored, they remain colored, in other words they remain marked.
The processor unit which sends the token becomes the “predecessor”, and the link to it becomes the channel. From then on, the colored tile, that is to say the marked processor unit, now accepts a token only from the respective predecessor.
Tokens are, in one case, sent via channels.

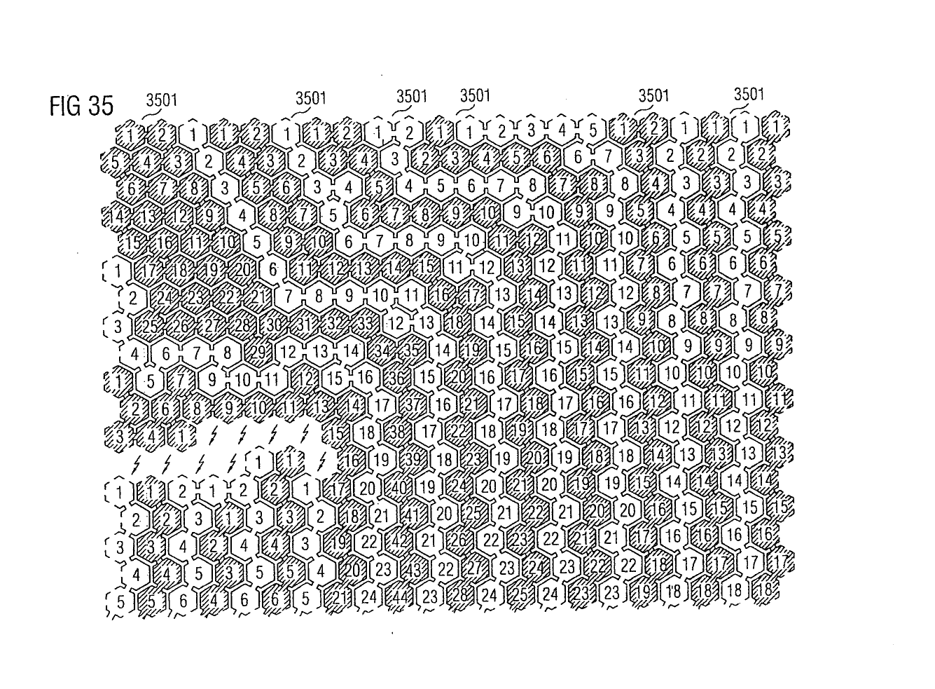

Once the processor arrangement 1800, 2100 has been colored completely, reorganization within the colored areas is required since the method element does not result in the formation of optimum “meandering channels” 3501, as illustrated by way of example in FIG. 35.

First of all, the method elements for processing of the messages that are used for allocation of token will be described in the following subsections.

The distance determination process within a color region is very largely identical to the general distance determination process, as described above, to a reference position.

The color distance in this case determines the length of the shortest path from a tile to the portal processor, in which case all of the tiles on the path must belong to the same color region.

For initialization, the color distance of each tile is defined as being infinite, and its color is undefined. On the basis of this exemplary embodiment, the distance from each tile to the portal processor is defined as a value which is greater than a maximum value which may be assumed as a distance within the tile arrangement. The processor unit likewise marks its adjacent processor units, and thus its adjacent tiles as being undefined, colored with the color distance infinity.

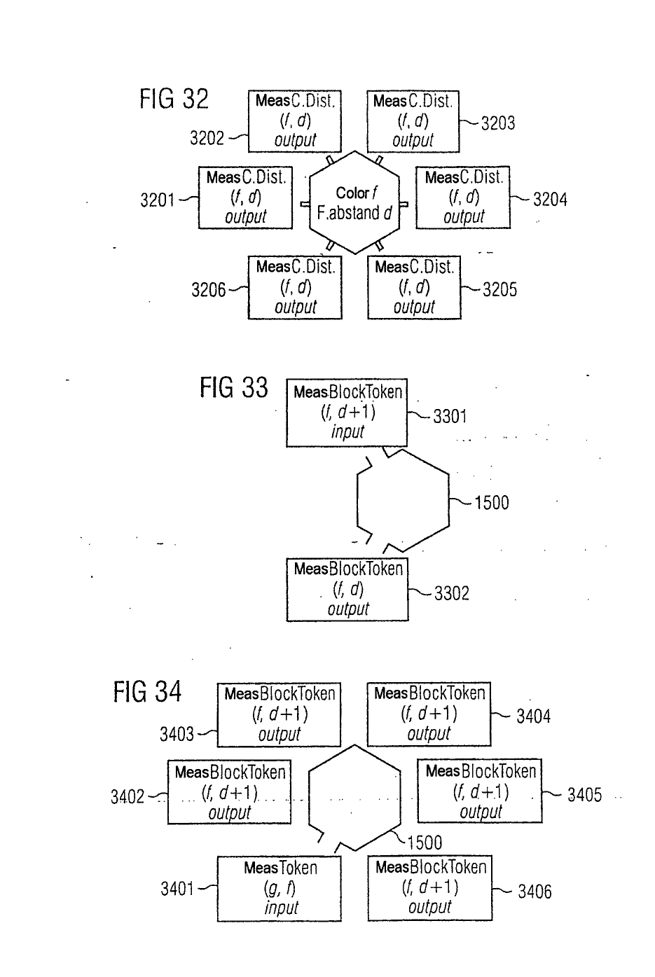

On receiving a measurement color distance message with the color c and the color distance parameter a the respective processor unit which receives the measurement color distance message carries out the following steps:
1. The processor unit which sends the measurement color distance message is marked with the color c and the color distance a.
2. If the color c does not match its own color f, that is to say the color f of the processor unit which receives the measurement color distance message, then the processing is ended.
3. Its own color distance d is set as the minimum of the color distances of neighbors marked with the same color plus the value 1.
4. If step 3 has resulted in a change in its own color distance d, then measurement color distance messages 3201, 3202, 3203, 3204, 3205, 3206 are sent via all the links with the parameters (f, d), that is to say, in other words, with its own color distance d and its own color f (see FIG. 32).

According to one embodiment of the invention, measurement block token messages are used to block adjacent processor units to prevent them from receiving token messages, that is to say, once one such a measurement block token message has been received, no more tokens may be sent to these blocked adjacent processor units.

The color and color distance are signaled at the same time, as for the measurement color distance message.

For initialization, all the adjacent processor units to a processor unit are set to be unblocked.

On receiving an incoming measurement block token message 3301 with the color c and the color distance parameter a as the message parameters, the respective processor unit which receives the measurement block token message carries out the following steps:
1. The processor unit which sends the measurement block token message is set to be blocked, and is marked with the color c and the color distance a.
2. If the color c does not match its own color f, that is to say the color of the processor unit which receives the measurement block token message, the processing is continued with step 5, which is described further below.
3. Its own color distance d is set as the minimum of the color distances of adjacent processor units marked with the same color plus the value 1.
4. If step 3 has resulted in a change in its own color distance d, then the processor unit sends measurement color distance messages 3201, 3202, 3203, 3204, 3205, 3206 via all the links with parameters (f, d), as illustrated in FIG. 32.
5. If there is one input channel and all the adjacent processor units are set to be blocked, then a measurement block token message 3302 with the parameters (f, d) is produced and is sent via the input channel, as illustrated in FIG. 33.

According to one embodiment of the invention, so-called measurement token messages are used for coloring, that is to say for marking processor units and thus for definition of color regions, that is to say areas to be marked within the processor arrangement 1800, 2100.

When processing measurement token messages, a distinction is drawn as to whether the processor unit is still uncolored or has already been colored by a token.

On receiving an incoming measurement token message 3401 with the weight g and the color f as message parameters, an uncolored processor unit which receives the measurement token message 3401 carries out the following steps:
1. The color distance pd, which is potentially its own color distance, is set as the minimum of the color distances of adjacent processor units colored with the color f,+1.
2. If the weight is g≦pd−a, where a is the distance (not the color distance!) of the processor unit from the portal processor, then the processor unit which sends the measurement token message 3401 is sent a measurement block token message and the processing is ended (the propagation of the tokens is thus restricted by a relaxed distance).
3. The processor unit which sends the measurement block token message 3401 is set to be blocked. Its own color is set as f, and its own color distance is set as pd.
4. The processor unit which sends the measurement token message 3401 is sent a measurement channel message, and the processor unit is set as being organized. The input channel is thus defined.
5. Measurement block token messages 3402, 3403, 3404, 3405, 3406 are sent via all the links with the exception of the input channel for the processor unit 1500, as illustrated in FIG. 34, in order to prevent tokens being allocated from there.
6. If all of the adjacent processor units have been set to be blocked, then a measurement block token message 3402, 3403, 3404, 3405, 3406 is sent via the input channel, as illustrated in FIG. 33.

On receiving a measurement token message with the weight g and the color f via the input channel the procedure for a processor unit that has already been colored is, in contrast, different.

Let us consider a sequence R=(SE, SW, E, W, NE, NW) for an even column number, which corresponds to a sequence R of (southeast, southwest, east, west, northeast, northwest) and, for an odd column number, a sequence R=(SW, SE, W, E, NW, NE), which corresponds to a sequence (southwest, southeast, west, east, northwest, northeast), with the following method steps being carried out:
1. If the received measurement token message did not arrive via the input channel or the color f does not match its own color, the processing is ended.
2. If there is an unblocked output channel after the sequence R, then a measurement token message with the parameters (g, f) is sent via this output channel, that is to say the token is passed on, and the processing is ended.
3. If there is an unblocked link after the sequence R, then a measurement token message (g, f) is sent via this link, and the processing is ended.
4. A measurement block token message is sent via the input channel, since the token cannot be passed on.

Since, during the choice of the color regions, the channels cannot be optimally set on the basis of the method element described above, as illustrated in FIG. 35, these channels are deleted by means of measurement delete channels messages, and are subsequently reset. In order to terminate the method element, the message is provided with a “stamp” parameter, whose value is not identical to the correspondingly stored parameter in the processor unit. In this context, it should be noted that the portal processor uses a different “stamp” parameter for each reorganization.

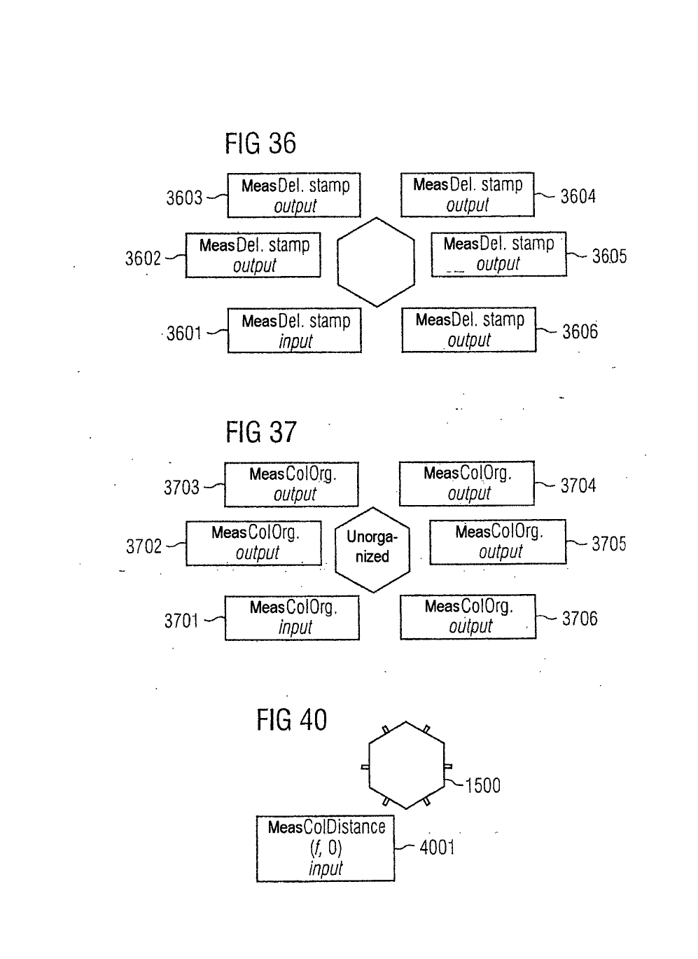

On receiving an incoming measurement delete channels message 3601 with the “stamp” parameter, the processor which receives the respective measurement delete channels message carries out the following steps:
1. If its own stamp parameter is identical to the received “stamp” parameter value, the processing is ended.
2. Its own stamp parameter is set to the value in the measurement delete channels message “stamp”.
3. All the channels are deleted.
4. Measurement delete channels messages 3602, 3603, 3604, 3605, 3606 with the “stamp” parameter are set via all the links with the exception of the link to the measurement delete to the processor unit which has sent the measurement delete channels message, as illustrated in FIG. 36.

After deletion of the old channels, new channels are set within a color region by the use of measurement color organize messages.

The processing of incoming measurement color organize messages 3701 and the sending of measurement color organize messages 3702, 3703, 3704, 3705, 3706 is very largely identical to the processing of measurement organize messages, as described above.

One difference, however, is that the adjacent processor units under consideration must be colored identically to the processing processor unit, and in that the color distance rather than the distance is used as the criterion.

All of the described steps as far as distance determination should have been carried out as described above in the tile array in order to carry out the method element described above.

As above in the first exemplary embodiment, the links are specifically referred to as “channels”.

In a first step, the portal processor in each case sends one measurement color distance message 4001 (see FIG. 40) with the parameters (f, 0) and with a different color parameter f via all of the links. All of the adjacent processor units thus mark the portal processor with a different color.

This ensures that an individual and unique marking is in each case produced, starting from each input processor unit.

In a second step, the portal processor sends successive measurement token messages via all the links with the parameters (g, f) and with the identical weight g ε N₀ and a different color parameter f, in order to color all of the processor units in the tile arrangement 1800, 2100.

The method element is terminated when measurement block token messages have arrived via all the links of the tile processor, that is to say when the tile arrangement 1800, 2100 has been completely colored.

In this context, it should be noted that the entire tile arrangement 1800, 2100 can always be completely colored using this method.

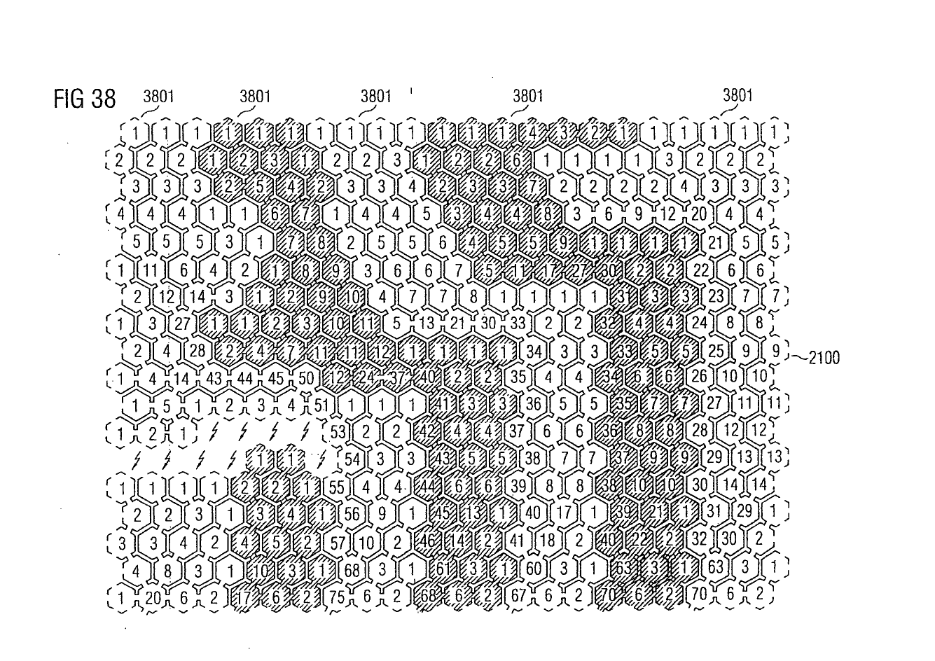

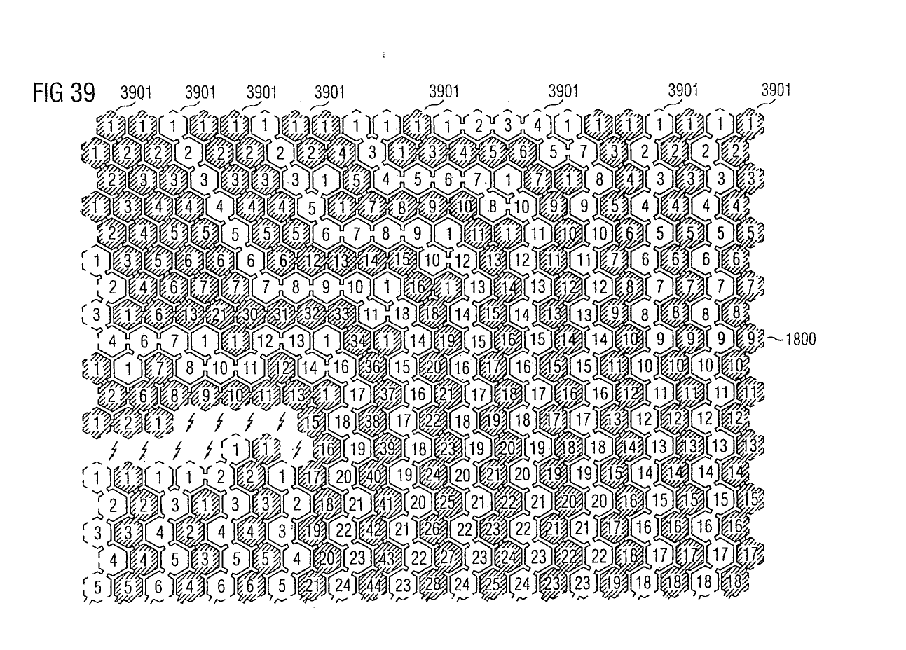

FIG. 38 illustrates the tile arrangement 2100 for the situation where it has been colored with the weight g=4 and in which the throughput has been represented on the basis of the organization. As can be seen in comparison with FIG. 30, which was formed by means of regular backward organization, the tree is considerably better balanced.

However, the configuration of this method element results in meandering paths 3801 being formed within the colored areas, so that the processor units are not connected to the portal processor by the shortest possible distance.

Thus, in a third step, the portal processor sends a measurement delete channels message via all of the links, as explained above, in order to delete the channels that have been formed. Directly after this message, a measurement color organize message is sent via all the links and forms new channels within the colored areas, which then represent the shortest links.

The method element is terminated once all of the processor units have been organized in this way. The number of clock cycles required to carry out the processes corresponds to the maximum color distance of a tile processor from the portal processor. In this case as well, one or two more clock cycles may be required before the last message communication “dies”.

The routing tree that is produced depends on the weight g which is included as a parameter in the respective measurement token message.

FIG. 39 illustrates the processor arrangement 1800 once reorganization has been carried out with a weight g=4 and the corresponding meandering paths 3901.

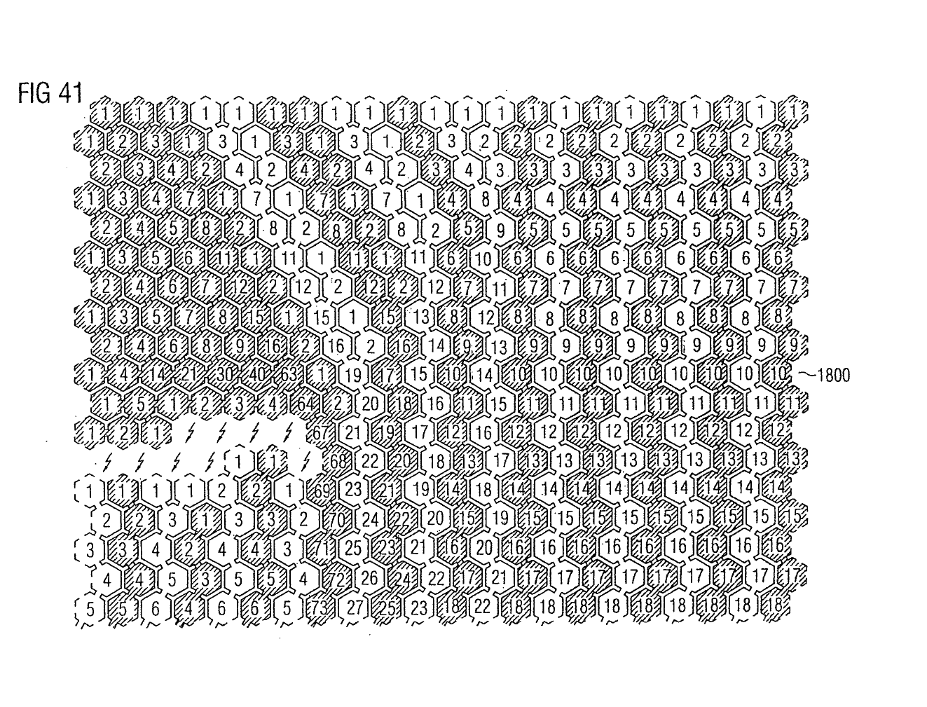

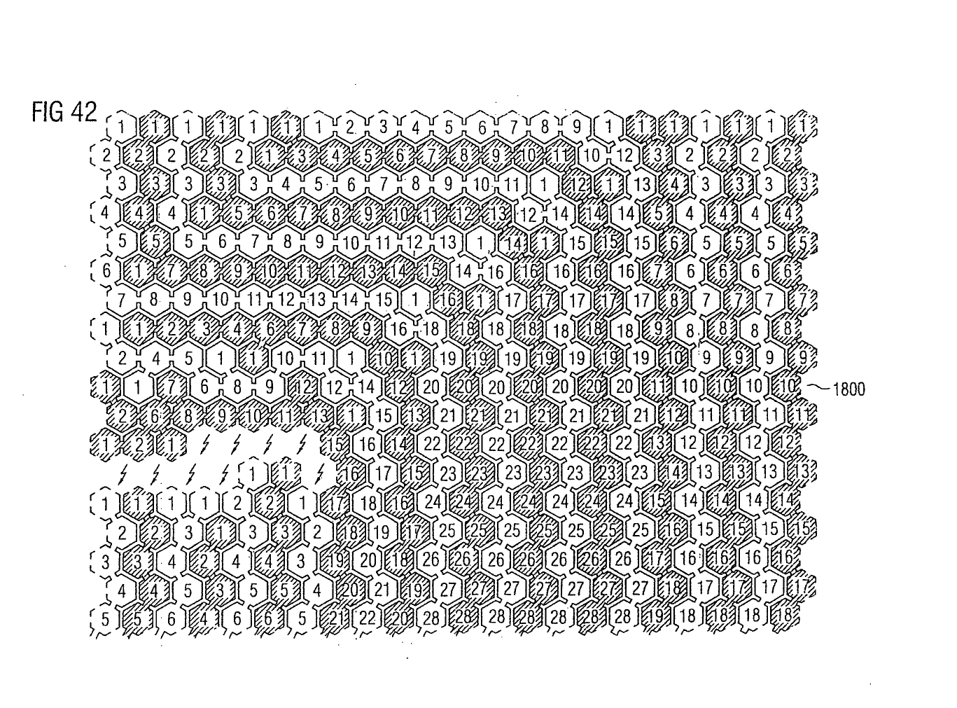

The weight g indicates by how much the color distance of a processor unit may be greater than the distance itself. The greater the weight g, the better balanced the resultant tree will normally be, but the longer the paths in this tree normally are, as well. In order to explain this, reference is made to FIG. 41, which illustrates the tile arrangement 1800 after the formation of the meandering paths with the weight g=0, and to FIG. 42 which illustrates the tile arrangement 1800 after the formation of the meandering paths with the weight g=∞.

The best choice of the weight normally depends on the transport characteristics of the respective links, that is to say of how many messages can be sent via a link per clock cycle. The smaller this number, the greater the best weight will normally have to be.

Two methods of selection of a routing tree have been described above.

Once a routing tree has been selected, that is to say once the appropriate channels have been selected, then an optimum routing for this tree can be determined in a very simple manner. The principles for this have been explained in the course of the description of the graph-theory principles.

In a first step, all of the tile processors, that is to say the processor units within the tile arrangement 1800, 2100, are numbered successively.

The numbers are then used as destination addresses during the routing process. In a second step, the local information that has been gathered is transmitted from the respective processor units to the portal processor. The overall routing table is then created in the portal processor.

According to this exemplary embodiment, measurement numbering messages are used for successively numbering all of the processor units in the tile arrangement 1800, 2100. This is dependent on the throughput of the respective processor units having already been determined, for example using the method element described above.

The method element for numbering is started by the portal processor by sending measurement numbering messages 4301 via the output channels of the portal processor, and with these being transmitted to the input processor units.

Once throughputs d₁, d₂, d₃, . . . have been determined for the corresponding adjacent processor units, then the respective measurement numbering message 4301 is also transmitted, with the parameters 1, 1+d₁, 1+d₁+d2, . . . as message parameters.

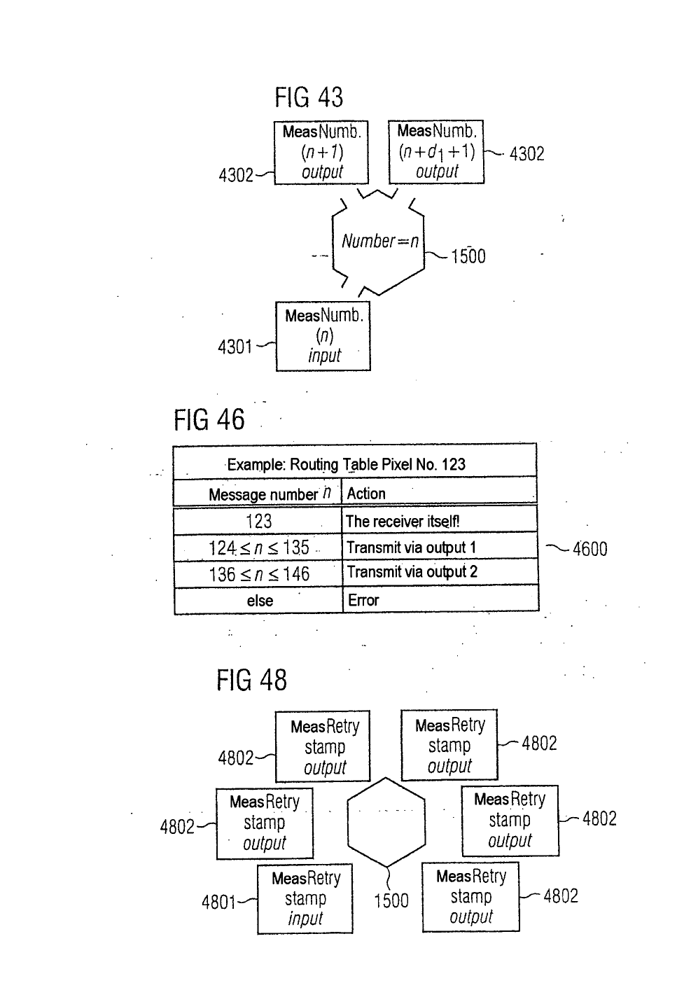

After reception of a measurement numbering message 4301 with the parameter n via the respective input channel of the processor unit (see FIG. 43), the processor unit which has received the measurement numbering message 4301 carries out the following steps:
1. The processor unit's own number is set to the value n, which corresponds to the value of the received measurement numbering message 4301.
2. One additional measurement numbering message 4302, which is produced by the processor unit, is produced in each case via all of the output channels of the processor unit and is sent with the parameters n+1, n+d₁+1, n+d₁+d₂+1, . . . , with d₁, d₂, . . . being the throughputs of the corresponding adjacent processor units.

The method element is terminated once the last processor has been numbered successively by the last processor unit. The number of clock cycles required to carry out the method element corresponds to the maximum distance of a processor unit via channels from the portal processor. In the case of this method element as well, one or two more clock cycles are also still required before the last message communication “dies”.

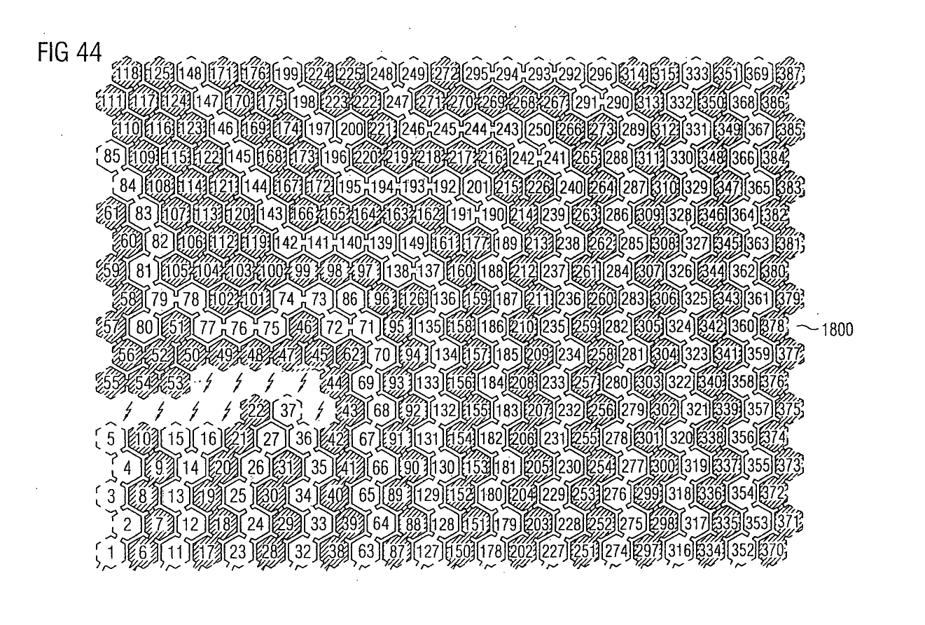

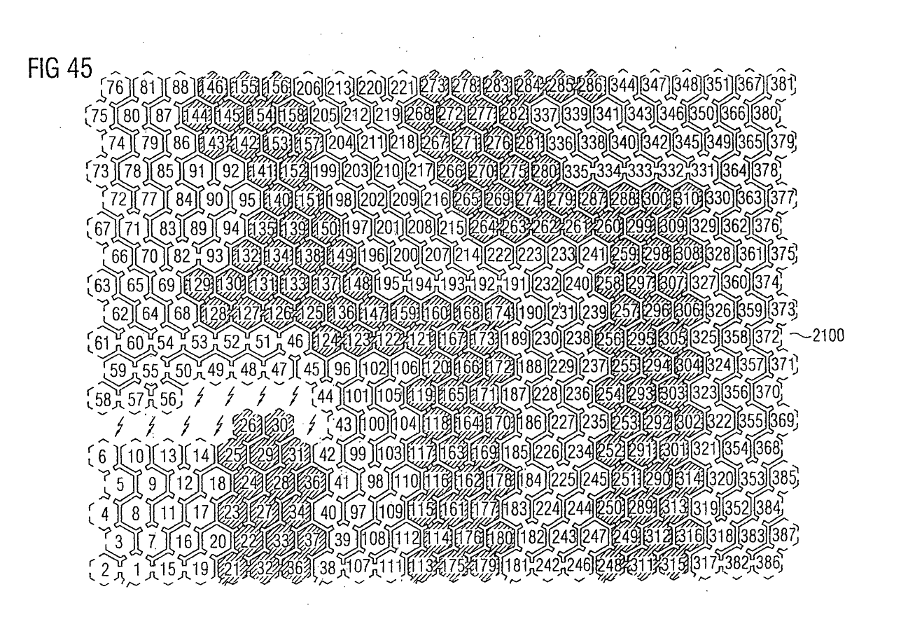

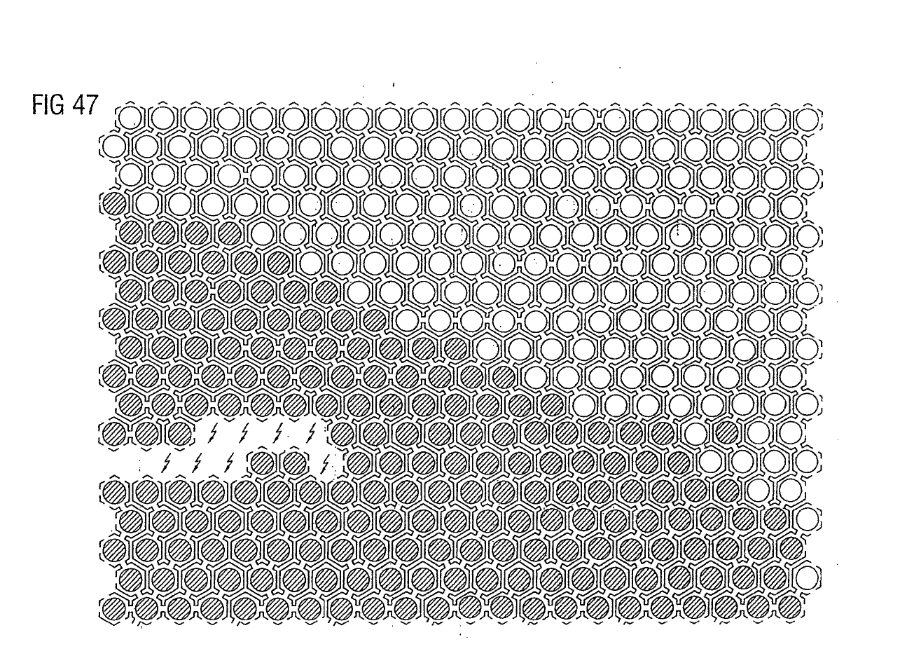

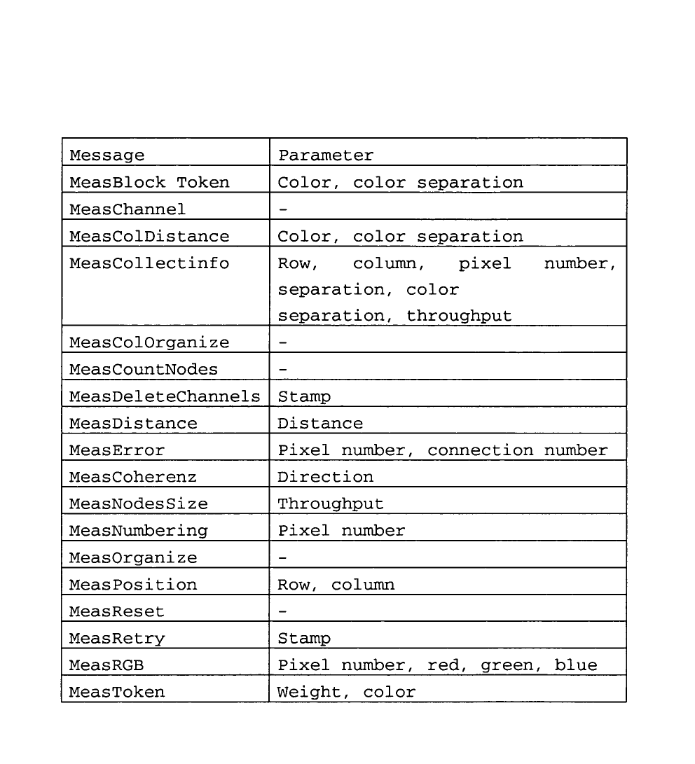

FIG. 44 and FIG. 45 illustrates the tile arrangements 1800 (FIG. 44) and 2100 (FIG. 45) once the individual processor units within the respective tile arrangement have been numbered.

The number of a processor unit can easily be used as an address for routing of data or else images since a unique number interval is allocated to each output channel of a processor unit. Each processor unit can thus set up a simple routing table.

By way of example, the table for the processor unit that has the number 123 is illustrated in the example in FIG. 45, as in the routing table 4600 in FIG. 46.

The locally produced information is signaled to the portal processor by means of measurement collect information messages, which contain the following message parameters:
the position of the respective processor unit within the respective tile arrangement, that is to say the row and the column in which the processor unit is located,
the tile number,
the distance value, which indicates the distance of the processor unit from the portal processor,
the color distance, and
the throughput of the processor unit.

The measurement collect information messages are in each case sent by the processor units as soon as the respective processor unit has been successively numbered.

This information allows the tile processor to read the information to be displayed, with the aid of the tile numbers.

By sending an overall image, that is to say by supplying the data to all of the processor units, the messages which are in this case sent first of all are those which have the longest path, as explained above in conjunction with the description of the graph-theory principles.

This routing table then also directly shows the routing duration, by means of which the routing trees are assessed.

Information to be displayed during further operation of the display can be sent in a very simple manner with the aid of the tile numbers and the routing tables, as described above. For this purpose, the portal processor sends messages of the measurement RGB type, which are provided with the following parameters:
the number of the tile which is being addressed, and
the color information for this tile, for example red/green/blue values or alternatively, only a drive signal for switching on a light-emitting diode which is integrated in the tile.

FIG. 47 illustrates an example of an information display on a tile arrangement. The illustration is, of course, independent of the selected routing tree.

The selection and the assessment of routing matrices have been described above, that is to say essentially routing paths. The assessment criterion in this case has been the routing duration. Since arbitrary combinational optimization based on the complexity normally cannot be carried out in a short time, an alternative has been proposed above.

The freely selectable parameter is the weight g. This process can also be carried out more than once by the portal processor using a different weight g for (partial) optimization of the routing duration.

The weight g=0, 1, 2, 3, . . . will normally be considered and investigated.

These have been found to be advantageous for numerical analyses. That routing which has the shortest routing duration can then be used as the final routing.

In order to allow the process to be carried out more than once, the portal processor uses the measurement retry message, which deletes all channels, color regions and color distances, as illustrated in FIG. 48. In order to terminate the process, the measurement retry message is provided with the “stamp” parameter, whose value is not identical to the corresponding stored parameter in the processor unit. In other words, the portal processor uses a different “stamp” parameter for each renewed resetting process.

On receiving an incoming measurement retry message 4801 with the “stamp” parameter, the respective processor unit which has received the measurement retry message 4801 carries out the following steps:
1. If its own stamp parameter is identical to the “stamp” parameter contained in the measurement retry message, the processing is ended.
2. Its own stamp parameter is set to the value of the “stamp” parameter value contained in the measurement retry message.
3. All numberings, channels, color regions, color distances and token blockings are deleted.
4. Additional measurement retry messages 4802 are transmitted via all the links with the exception of the link to the processor unit which is sending the measurement retry message, as is illustrated in FIG. 48.

During operation of the tile arrangement, wear can result in faults occurring which had not yet occurred at the time at which the self-organization process described above took place. Further messages may be used for self-identification of these faults.

On the basis of the model assumptions described above, the only fault which may occur from the point of view of a local processor is that an adjacent processor which has been linked to it until then can no longer be accessed. In contrast, it can also assess whether only the link to this adjacent processor or whether the adjacent processor itself has failed. In a situation such as this however, a fault message or error message, referred to in the following text as a measurement error message, can be sent to the portal processor which identifies it itself, in one case, using its own tile number as a message parameter and additionally contains the number of the newly failed link.

One possible reaction of the portal processor to a message such as this is a global reset of the tile arrangement, by means of a measurement reset message.

In reaction to this message, each tile processor passes on this message to all the adjacent processors and deletes all the data which has been determined during the organization process. In order to terminate this process, each tile processor should maintain a certain delay time before whose end it does not react to further messages. The dead time prevents the propagation of the measurement reset message being repeated indefinitely.

In summary, FIG. 49 illustrates an overview of the messages that are used, and their respective parameters.

In this context, it should be noted that the message catalogue can, of course, be functionally extended by adding any other desired additional messages.

The technical configuration of a tile 101 according to the invention can be designed in numerous individual variants for the sensor elements and display elements.

One elementary component of a tile, however, is the respective processor unit, which is coupled by means of electrical power supply lines and data lines to the processor units of directly adjacent tiles. When laying a tile floor or a tile wall, this results in a regular network, as has been explained above.

As explained above, the portal processor is, furthermore, provided at the edge of the network, that is to say at the edge of the tile arrangement 100. The portal processor is the central control component for building technology and exhibition technology. Information can be sent via the portal processor to the system, that is to say to the tile arrangement 100, as is illustrated in FIG. 4. However, sensor information can also be passed from the system to the portal processor 401.

The tile arrangement 100 is installed in accordance with the following individual steps:
first of all, the tiles or wall tiles are laid as normal, with the difference from the normal procedure that the tile connecting pieces are incorporated first of all, with the tiles subsequently being coupled to one another via the tile connecting pieces;
furthermore, the portal processor is connected to one or more tiles, which are in one case, located at the edge of the laid area, that is to say at the edge of the tile arrangement 100;
finally, the automatic self-organization of the network of the tile arrangement 100 is carried out in the manner described above, without any manual actions by the user.

This allows installations to be implemented without any specialist technical knowledge and without planning of line runs or programming of two-dimensional positions.

In consequence, the costs are considerably less than those of a specific solution, and the arrangement according to the invention is thus suitable for use in the mass market.

Furthermore, this results in a highly fault-tolerant system which can be used very well even in the event of malicious damage (in the case of alarm systems) or in the event of a catastrophe (for example for operation relating to the capability to use the system as a guidance system or as a detector of unconsciousness, even in the case of progressive destruction, for example by fire).

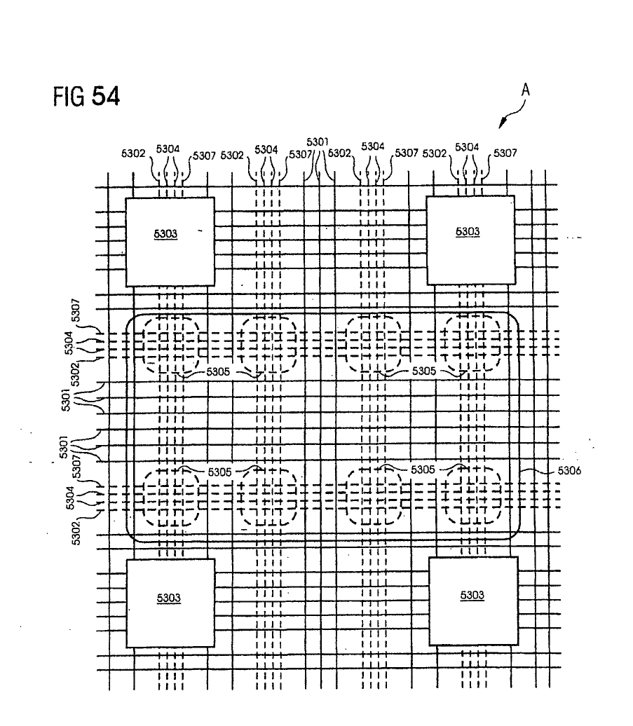

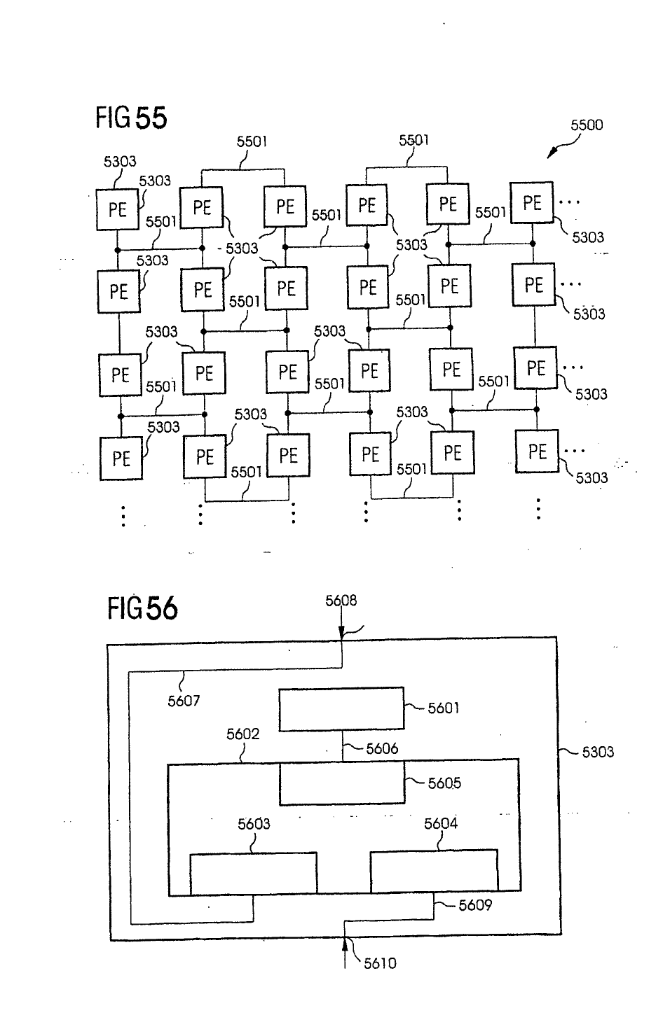

FIG. 53 illustrates a schematic illustration of a textile fabric structure 5300 according to one exemplary embodiment of the invention. FIG. 54 illustrates an enlarged detail A of the processor arrangement illustrated in FIG. 53.

The textile fabric structure 5300 has, as the basic structure, a large-mesh fabric which is formed from non-conductive threads 5301. In addition, the textile fabric structure 5300 has electrically conductive threads 5302, 5307. The electrically conductive threads 5302 are used for grounding for the processor elements 5303, which are to be integrated in the textile fabric structure 5300 and which will be explained in more detail in the following text.

The electrically conductive threads 5307 are used for supplying electrical power to the processor elements 5303 which are to be integrated in the textile fabric structure 5300. Furthermore, the textile fabric structure 5300 has conductive threads 5304, which are used for data transmission from and to the processor elements 5303 to be integrated.

The electrically conductive threads 5302, 5307 and the conductive data transmission threads 5304 are, in one case, arranged in a square pattern in the fabric, thus resulting in the formation of a square pattern of cross point areas 5305 (see FIG. 54) in the textile fabric structure 5300. In the areas in which the processor elements 5303 are inserted, the threads (both the electrically conductive threads 5302, 5307, the conductive data transmission threads 5304 and the non-conductive threads 5301) are removed, in one case, by being cut out, thus resulting in the formation of a gap in the textile fabric structure 5300, into which the processor elements 5303 are inserted.

Once the processor elements 5303 have been inserted into the textile fabric structure 5300, they are coupled to the respective threads at their outer connections, in particular at their communications interfaces, in particular to the electrically conductive threads 5302 and 5307 for the electrical power supply and, respectively for grounding of the respective processor element, and to the conductive data transmission threads 5304 for transmission of data between processor elements 5303 which are arranged mutually adjacent to one another.

Each processor element 5303 is thus supplied with electrical power by means of the electrically conductive threads 5302 and 5307, and electronic messages are interchanged between the processor elements 5303 by means of the data transmission threads 5304 in accordance with the respective communication protocol which is used depending on the configuration of the respective communication interface of the processor element.

As is indicated at the crossing point areas 5305 in FIG. 54, the conductive threads 5302, 5304, 5307 which each correspond to one another are coupled to one another, so this exemplary embodiment of the invention results in the formation of a ring structure 5306 of the data lines. This makes it possible for each processor element 5303 to transmit data to all four adjacent processor elements 5303 which are arranged adjacent to the respective processor element 5303 by means of in each case two communication interfaces for transmission of data.

The coupling between the processor element 5303 and the electrically conductive threads 5302 and 5307 and conductive data transmission threads 5304 can be provided by contact being made by means of a flexible printed circuit or by means of so-called wire bonding. The processor elements 5303 are encapsulated in the textile fabric structure 5300, such that the coupling area between the processor element 5303 and the electrically conductive threads 5302 and 5307 and the conductive data transmission threads 5304 is insulated, thus also ensuring mechanically robust and waterproof protection.

An “intelligent” textile fabric structure 5300 such as this can be used as the basis or as an intermediate layer of wall paneling or floor paneling, or some other type of technical textiles. It can also be used, by way of example, as a layer in a textile concrete structure. The processor elements 5303 in the textile fabric structure 5300 can be coupled to a large number of different types of sensors and/or actuators, or may contain such sensors and/or actuators. Light-emitting diodes, display elements or displays for displaying information which is transmitted to the processor elements 5303 can thus be contained in the processor element 5303, or can be connected to it.

The electrically conductive threads 5302 and 5307 as well as the conductive data transmission threads 5304 are woven into the textile fabric structure 5300. The conductive threads 5302, 5307 and the conductive data transmission threads 5304 make contact with supply lines and data lines (not illustrated) on the four sides of the textile fabric structure 5300. According to one refinement of the invention, a carpet base is fixed on the textile fabric structure 5300.

The textile fabric structure 5300 according to one embodiment of the invention, with integrated microelectronics, sensors and/or actuators, for example small indicating lamps, is functional in its own right and can be fixed under different types of surface paneling. Examples of surface paneling such as this are non-conductive textiles, floor coverings composed of carpet bases, parquet flooring elements, plastic, drapes, wallpaper, insulating mats, tent roofs, plaster layers, paintwork and textile concrete. They are in one case fixed by means of adhesion, lamination or vulcanization. In order to avoid “electrosmog” in the vicinity of people, a textile through which electrically conductive wires pass uniformly can also be applied over the textile fabric structure 5300 according to one embodiment of the invention, in order to screen it. In this case, care should be taken, however, to ensure that, if appropriate, certain areas, for example areas above capacitance sensors are not covered by the shielding.

The textile fabric structure 5300 with integrated microelectronics is in one case coupled at a point at the edge of the textile fabric structure 5300 to a central control unit, for example a simple personal computer, referred to in the following text as an interface processor 5308, by means of an electrical connecting line 5309.

An evaluation system 5310, in the form of a personal computer, and/or a control system 5310 is coupled to the interface processor 5308, by means of which electronic messages are read in from the interface processor 5308 or are passed to the processor arrangement 5300, that is to say in other words they are sent to the processor elements 5303 in the processor arrangement 5300, in particular in order to control an actuator which is coupled to the respective processor for the processor element 5303.

According to these exemplary embodiments of the invention, as they will be explained in more detail in the following text, the self-organization process, as is described above and in T. F. Sturm, S. Jung, G. Stromberg, A. Stöhr, A Novel Fault Tolerant Architecture for Self-Organizing Display and Sensor Arrays, International Symposium Digest of Technical Papers, Volume XXXIII, Nr. II, Society for Information Display, Boston, Mass., May 22 to 23, 2002, pages 1316 to 1319, 2002, is carried out at the start of use of the textile fabric structure 5300.

When the textile fabric structure 5300, which thus has a network of processor elements 5303, is used for the first time, then the learning phase which has been described above and in T. F. Sturm, S. Jung, G. Stromberg, A. Stöhr, A Novel Fault Tolerant Architecture for Self-Organizing Display and Sensor Arrays, International Symposium Digest of Technical Papers, Volume XXXIII, Nr. II, Society for Information Display, Boston, Mass., May 22 to 23, 2002, pages 1316 to 1319, 2002 starts, after the completion of which each processor element 5303 knows its exact physical position within the textile fabric structure 5300 with respect to a reference position, in one case, with respect to the position of the interface processor 5308. Furthermore, automatic paths for data streams are configured through the pattern, so that sensor information or display information can be passed around areas that have been determined to be defective within the textile fabric structure 5300.

The self-organization process of the network identifies and circumvents defective areas. In consequence, the network composed of processor elements 5303 remains functional even when the textile fabric structure 5300 is cut to a shape which is predetermined by the respective application.

Furthermore, the self-organization process according to one embodiment of the invention means that no manual installation effort is required for the network of processor elements 5303 within the textile fabric structure 5300.

As can be seen, the processor elements 5303 according to this exemplary embodiment of the invention are thus coupled to one another with the aid of local ring structures. Each processor element 5303 is connected to two, and only two, rings 5306, formed by ring lines, which means that just two communication interfaces per processor element 5303 are sufficient for communication with four neighboring processor elements that are arranged adjacent.

At the edges of the textile fabric structure 5300, the ring structure is degenerated to form a point-to-point link, that is to say as can be seen to form a ring composed of two subscribers, although this has no influence on the design of the processor elements 5303. As is illustrated in FIG. 54, the already existing conductive threads 5302, 5304, 5307 in the matrix arrangement of the textile fabric structure 5300 can be used as illustrated in FIG. 53 to form local ring topologies.

FIG. 56 illustrates an example of a processor element 5303 as is used in all the exemplary embodiments of the invention.

The processor element 5303 has a sensor 5601 as well as a processor 5602, for example an XC161 or XC164 microcontroller from the company Infineon Technologies AG.

The processor 5602 has a first communication interface 5603 and a second communication interface 5604. The sensor 5601 is coupled to a data input connection 5605 by means of a connecting line 5606. The first communication interface 5603 is coupled via a second connecting line 5607 to a first input/output interface connection 5608, and the second communication interface 5604 is connected by means of a third connecting line 5608 to a second input/output interface connection 5610.

The sensor 5601 is in one case in the form of a pressure sensor, so that the textile fabric structure 5300 can be used to locally resolve someone stepping onto the carpet in which the textile fabric structure 5300 is incorporated. A carpet such as this can in one case be used in a warehouse, in which the attractiveness of individual goods locations is intended to be determined on the basis of time for which the purchasers remain there, or particularly long waiting lines in a checkout area are intended to be detected automatically in order to open further checkouts if required. Another field of application for a textile fabric structure such as this is alarm systems.

The two input-output interface connections 5608 and 5610 are arranged on mutually opposite sides of the processor element 5303.

Further elements of the processor element 5303, such as memory elements, clock production devices, voltage supply, etc, are not illustrated in FIG. 56, for reasons relating to clarity, but are provided in the processor element 5303.

The processor 5602 is in one case designed in such a way that sensor data detected by the sensor 5601 and transmitted to the processor 5602 is preprocessed, and is then transmitted to the interface processor 5308 via the conductive threads.

In general, any desired number of interface processors 5308 are provided in the processor arrangement, in one case in the textile fabric structure 5300.

In this context, it should be noted that the processor element 5303 can alternatively, or in addition to the sensor 5601, contain an actuator, for example an imaging element, in one case a light-emitting diode.

The connecting structure in FIG. 53 is illustrated in a simplified form in comparison to the illustration in FIG. 54, since only the data lines 5302 are illustrated there.

In this context, it should be noted that some of the connecting lines, that is to say some of the threads are optional for the functionality of the textile fabric structure 5300, thus resulting in a range of specific implementations by the omission of redundant connecting lines in the textile fabric structure 5300.

FIG. 55 illustrates a processor arrangement, likewise in the form of a textile fabric structure 5500, according to an exemplary embodiment of the invention.

In contrast to the textile fabric structure 5300 according to the above exemplary embodiment of the invention, the processor elements 5303 in the textile fabric structure 5500 according to this exemplary embodiment of the invention are coupled to one another by means of a two-value bus coupling topology using a standard bus communication protocol, for example using an SPI bus or an I²C bus or a CAN bus.

In this situation, the communication interfaces 5603, 5604 are designed for communication in accordance with the respective bus communication protocol. This means that the communication interfaces 5603, 5604 may be designed, for example, as an SPI interface (or as an SSP interface), as an I²C interface or as a CAN interface.

In general, it should be noted that the topology of the local links between the processor elements is governed by the nature of the connection of the processor elements 5303 to the data lines, which are in the form of a grid, in the textile fabric structure, in general the processor arrangement.

In other words, this means that the textile fabric structure 5500 according to this exemplary embodiment of the invention is designed in such a way that the processor elements are coupled using local buses and by using standardized communication interfaces, which are already in widespread use, particularly in the microcontroller field.

The connecting lines of the buses according to this exemplary embodiment are provided with the reference symbol 5501 in FIG. 55.

Four or two processor elements 5303 (processor elements 5303 which are arranged at the edge of the processor arrangement 5500) are connected to each bus connecting line 5501, each of which has two communication interfaces 5603, 5604, as described above.

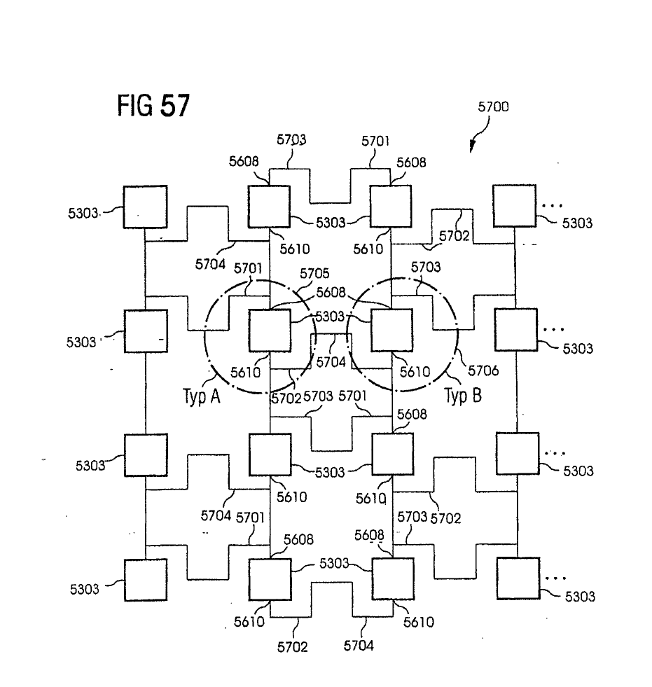

FIG. 57 illustrates a processor arrangement 5700 according to another exemplary embodiment of the invention.

A bus 5701 for coupling of the processor element 5303 is also provided according to this exemplary embodiment of the invention.

As can be seen from FIG. 57, when using the optional connecting lines, just two types of local connection topologies are sufficient for connection of the processor elements 5303 which are arranged physically directly adjacent to one another, specifically connections
a) viewed from the respective processor element 5303, between the left and upper electrical line 5701 with the first input/output interface connection 5608 of the processor element 5303 and between the right and lower line 5702 with the second input/output interface connection 5610 of the processor element 5303 (which is also referred to in the following text as the first type 5705), and
b) seen from the respective processor element 5303, between the right and upper line 5703 with the first input/output interface connection 5708 of the processor element 5303, and between the left and lower line 5704 with the second input/output interface connection 5710 of the processor element 5303 (also referred to in the following text as the second type 5706).

The connection topologies of the first type 5705 and of the second type 5706 are arranged both vertically and horizontally alternately with respect to one another, that is to say like a checkerboard pattern. The small range of types of connections and the identical nature and simple design of the processor elements 5303 lead to a particularly low-cost implementation of the processor arrangement 5700 according to this exemplary embodiment of the invention.

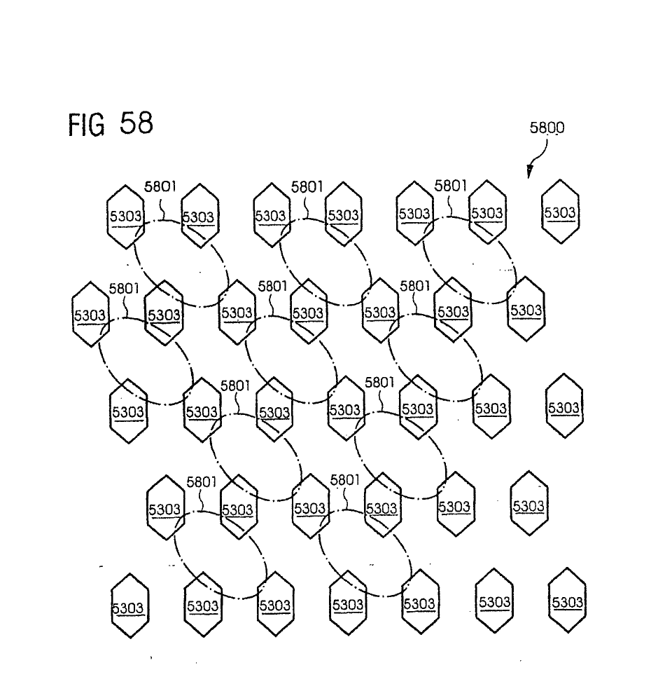

FIG. 58 illustrates a processor arrangement 5800 according to another exemplary embodiment of the invention.

According to the exemplary embodiment of the invention, the processor elements 5303 are arranged in a hexagonal shape, but have the same elements as those described above.

In the same way, a ring topology, that is to say a connection between mutually adjacent processor elements 5303 by means of a ring structure 5801, as is illustrated in FIG. 58, is provided for coupling of the hexagonal processor elements 5303 in the processor arrangement 5800.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. (canceled)

2-23. (canceled)

24. A method for determining a distance from surface paneling modules of a surface paneling module arrangement to at least one reference position, with electronic messages being interchanged between processor units of mutually adjacent surface paneling modules, wherein the surface paneling module arrangement has two or more surface paneling modules, and each surface paneling module comprises:
at least one electrical power supply connection;
at least one data transmission interface;
at least one processor unit which is coupled to the electrical power supply connection and to the data transmission interface;
wherein the processor unit is designed such that electronic messages are interchanged between the processor unit and a processor unit for an adjacent surface paneling module, which is coupled to the surface paneling module, in order to determine the respective distance of a processor unit from a reference position;
wherein each message contains distance information which indicates the distance of the surface paneling module of a processor unit which is sending the message or the distance of the surface paneling module of a processor unit which is receiving the message from the reference position;
wherein the processor unit is designed such that the actual distance to the reference position can be determined or can be stored from the distance information in a received message;
wherein the method, which is carried out for all the surface paneling modules in the surface paneling module arrangement, comprising:
producing a first message with a processor unit of a first surface paneling module, with the first message containing first distance information which contains the distance of the first surface paneling module or the distance of a second surface paneling module which receives the first message from the reference position;
sending the first message from the processor unit of the first surface paneling module to the processor unit of the second surface paneling module;
determining the distance of the processor unit of the second surface paneling module from the reference position as a function of the distance information;
wherein the processor unit of the second surface paneling module produces a second message which contains second distance information which contains the distance of the second surface paneling module or the distance of a third surface paneling module which receives the second message, from the reference position;
sending the second message from the processor unit of the second surface paneling module to the processor unit of the third surface paneling module;
determining the distance of the third surface paneling module from the reference position as a function of the second distance information;
wherein before the determination of the distance of the surface paneling modules from the reference position, the physical positions of the surface paneling modules within the surface paneling module arrangement are determined in that, on the basis of a surface paneling module at an introduction point of the surface paneling module arrangement, position determination messages which have at least one row parameter z and one column parameter s (which contains the row number or column number, respectively, of the processor unit sending the message or the row number or the column number, respectively, of the processor unit receiving the message within the surface paneling module arrangement) are in each case transmitted to processor units of adjacent surface paneling modules, and the respective processor unit carries out the following steps:
if the row parameter in the received message is greater than the previously stored row number of the processor unit, then the processor unit's own row number is allocated the row parameter value z of the received message;
if the column parameter in the received message is greater than the processor unit's own column number, then the stored column number is allocated the row parameter value of the received message; and
if its own row number or its own column number has been changed on the basis of the method steps described above, then new position measurement messages are produced with new row parameters and new column parameters, which each contain the row number and the column number of the processor unit sending the message or the row number and the column number of the processor unit receiving the message, and these are transmitted to a processor unit of a respective adjacent surface paneling module.

25. The method of claim 24:
wherein in an iterative method, the processor unit of the surface paneling module's own distance value is changed if the previously stored distance value is greater than the received distance value (increased by a predetermined value) in the respectively received message; and
wherein in the situation where a processor unit of a surface paneling module changes its own distance value, this produces a distance measurement message and sends this to processor units of adjacent surface paneling modules, with the distance measurement message in each case containing its own distance as distance information or the distance value which the receiving processor unit has from the portal processor.

26. The method of claim 25, wherein the distance value has a value which is greater by a predetermined value than its own distance value.

27. The method of claim 24, wherein each surface paneling module has a plug connector in which the electrical power supply connection and the data transmission interface are integrated.

28. The method of claim 24, wherein each surface paneling module has at least one electrical power line and at least one data line, wherein the processor unit is coupled to the electrical power supply connection by means of the electrical power line, and is coupled to the data transmission interface by means of the data line.

29. The method of claim 24, wherein each surface paneling module is designed as one of the group comprising:
wall paneling module, floor paneling module, and ceiling paneling module.

30. The method of claim 24, wherein each surface paneling module is designed as one of the group comprising:
a tile, a wall tile, a parquet flooring element, and a laminate element.

31. The method of claim 24, wherein at least some of the surface paneling modules have at least one sensor which is coupled to the processor unit.

32. The method claim 24, wherein at least some of the surface paneling modules have at least one of the group comprising:
imaging element, sound wave production element, and vibration production element.

33. A surface paneling module arrangement having two or more surface paneling modules, each surface paneling module comprising:
at least one electrical power supply connection;
at least one data transmission interface;
at least one processor unit which is coupled to the electrical power supply connection and to the data transmission interface;
the processor unit being designed such that electronic messages are interchanged between the processor unit and a processor unit for an adjacent surface paneling module, which is coupled to the surface paneling module, in order to determine the respective distance of a processor unit from a reference position;
each message containing distance information which indicates the distance of the surface paneling module of a processor unit which is sending the message or the distance of the surface paneling module of a processor unit which is receiving the message from the reference position; and
the processor unit being designed such that the actual distance to the reference position can be determined or can be stored from the distance information in a received message;
wherein the surface paneling module arrangement is designed to carry out a method for determining a distance from surface paneling modules of a surface paneling module arrangement to at least one reference position, with electronic messages being interchanged between processor units of mutually adjacent surface paneling modules, the method, which is carried out for all the surface paneling modules in the surface paneling module arrangement comprising:
providing a first message by a processor unit of a first surface paneling module, with the first message containing first distance information which contains the distance of the first surface paneling module or the distance of a second surface paneling module which receives the first message from the reference position;
sending the first message from the processor unit of the first surface paneling module to the processor unit of the second surface paneling module;
determining the distance of the processor unit of the second surface paneling module from the reference position as a function of the distance information;
wherein the processor unit of the second surface paneling module produces a second message which contains second distance information which contains the distance of the second surface paneling module or the distance of a third surface paneling module which receives the second message, from the reference position;
sending the second message from the processor unit of the second surface paneling module to the processor unit of the third surface paneling module;
determining the distance of the third surface paneling module from the reference position as a function of the second distance information;
wherein the surface paneling module arrangement is designed such that before the determination of the distance of the surface paneling modules from the reference position, the physical positions of the surface paneling modules within the surface paneling module arrangement are determined in that, on the basis of a surface paneling module at an introduction point of the surface paneling module arrangement, position determination messages which have at least one row parameter z and one column parameter s (which contains the row number or column number, respectively, of the processor unit sending the message or the row number or the column number, respectively, of the processor unit receiving the message within the surface paneling module arrangement) are in each case transmitted to processor units of adjacent surface paneling modules, and the respective processor unit carries out the following steps:
if the row parameter in the received message is greater than the previously stored row number of the processor unit, then the processor unit's own row number is allocated the row parameter value z of the received message;
if the column parameter in the received message is greater than the processor unit's own column number, then the stored column number is allocated the row parameter value of the received message; and
if its own row number and/or its own column number have/has been changed on the basis of the method steps described above, then new position measurement messages are produced with new row parameters and new column parameters, which each contain the row number and the column number of the processor unit sending the message or the row number and the column number of the processor unit receiving the message, and these are transmitted to a processor unit of a respective adjacent surface paneling module.

34. A textile fabric structure having a processor arrangement, the processor arrangement comprising:
at least one interface processor which provides a message interface for the processor arrangement;
a large number of processors, with, at least in some cases, only those processors which are arranged physically directly adjacent to one another being coupled to one another in order to interchange electronic messages;
with each processor of the large number of processors being allocated a sensor and/or an actuator and being coupled to the respective processor with sensor data and/or actuator data being transmitted in the electronic messages from and/or to the interface processor;
with the processors which are arranged physically directly adjacent to one another at least in some cases being coupled to one another in accordance with a regular coupling topology whose degree is greater than unity;
wherein the processors or sensors or actuators are arranged in the textile fabric structure;
wherein electrically conductive threads couple the processors to one another;
wherein conductive data transmission threads couple the processors to one another; and
having electrically non-conductive threads.

35. The textile fabric structure of claim 34, wherein the processors which are arranged physically directly adjacent to one another are coupled to one another in accordance with a regular bus coupling topology.

36. The textile fabric structure of claim 35, wherein the processors which are arranged physically directly adjacent to one another are coupled to one another in accordance with a regular ring coupling topology.

37. The textile fabric structure of claim 35, wherein the regular bus coupling topology is designed in accordance with one of the group of communication interface standards comprising serial parallel interface, controller area network interface, and I²C interface.

38. The textile fabric structure of claim 34, wherein the processors are arranged in rows and columns in the form of a matrix.

39. The textile fabric structure of claim 34, wherein the electrically conductive threads are designed such that they can be used to supply power to the two or more processors and/or sensors and/or actuators.

40. The textile fabric structure of claim 34, wherein the conductive data transmission threads are electrically conductive.

41. The textile fabric structure of claim 34, wherein the conductive data transmission threads are optically conductive.

42. The textile fabric structure of claim 34, wherein the actuator is designed as at least one of the group of elements comprising imaging element, sound wave production element, and vibration production element.

43. The textile fabric structure of claim 34, wherein a surface paneling structure is fixed on the textile fabric structure.

44. The textile fabric structure of claim 43, wherein the surface paneling is adhesively bonded and/or laminated and/or vulcanized onto the textile fabric structure.

45. The textile fabric structure of claim 43, wherein the surface paneling structure is designed as one of the group comprising wall paneling structure, floor paneling structure, and ceiling paneling structure.

46. The textile fabric structure of claim 43, wherein a textile layer through which electrically conductive wires pass uniformly is applied at least over subareas of the textile fabric structure.
